(19) United States
(12) Patent Application Publication
(10) Pub. No.: US 2023/0169826 A1
(43) Pub. Date: Jun. 1, 2023

(54) CASINO PLAYER LOYALTYS TO CRYPTOCURRENCY AWARDS

(71) Applicant: IGT, Las Vegas, NV (US)

(72) Inventors: Kevin Higgins, Reno, NV (US); Dwayne Nelson, Las Vegas, NV (US)

(21) Appl. No.: 17/537,099

(22) Filed: Nov. 29, 2021

(51) Int. Cl. G07F 17/32; G06Q 20/38; G06Q 20/36; G06Q 30/02

(52) U.S. Cl. CPC G07F 17/3255; G06Q 20/381; G06Q 20/3676; G06Q 20/3829; G06Q 30/0226; G07F 17/3239; G06Q 2220/00

(57) ABSTRACT

A gaming system that exchanges loyalty points and cryptocurrency in a secure manner with respect to transactions between a gaming establishment account associated with a player and an external cryptocurrency account of the player.

### BACKGROUND

The present disclosure is related to gaming systems and devices and, in particular, the use of such devices in connection with converting nonmonetary loyalty points to cryptocurrency and vice versa.

In a typical casino, a player loyalty system allows casino patrons to sign up for a player loyalty account. After providing the casino with personally identifiable information (e.g., name, home address, etc.) and optionally verifying his or her identity (via presentation of a government issued identification as required by the jurisdiction), the player is typically given a player loyalty card. Players can then present their player loyalty card throughout the casino when gambling or performing a purchase to earn rewards that can take numerous forms, including player loyalty points and free play (Xtra-Credit, etc.).

Loyalty points can be redeemed by players for free play or to pay for goods or other offers within the casino. For example, a player may be able to redeem 1000 points for a determined dollar value of free play. Players often accrue very large point balances over time and spending them can be quite difficult, especially when players are geographically separated from the casino which they like to visit only once or twice a year, particularly if the casino has a points expiration program where points may expire a certain time period after issuance. To address this need by players to remotely redeem points, some casinos allow remote redemption of points for non-gambling use cases where players can redeem points for items such as gifts on a web site or to purchase magazine subscriptions or other items. Even these remote redemption programs have minimal offerings.

### BRIEF SUMMARY

In certain embodiments, the present disclosure relates to a gaming system that can convert loyalty points to cryptocurrency and cryptocurrency to loyalty points.

In some embodiments, a method for digital ledger validation in a gaming system, comprises: monitoring, by a microprocessor, player activity on a plurality of gaming devices; in response to a monitored player activity of a selected player complying with a set of promotional rules, awarding, by the microprocessor, a loyalty point to the selected player, the loyalty point being assigned independently of an outcome of a game on the plurality of gaming devices; receiving, by the microprocessor, a request to convert the loyalty point into a selected cryptocurrency for transfer into a digital account associated with the selected player; determining, by the microprocessor, that the selected player request complies with a set of conversion rules different from the set of promotional rules; in response to the determining, applying, by the microprocessor, a first conversion ratio associated with the selected cryptocurrency to the loyalty point to provide a converted amount of the selected cryptocurrency; and causing the digital account of the selected player to be updated to reflect the applying by decrementing a loyalty point balance of the selected player and incrementing a balance of the selected cryptocurrency.

In some embodiments, a gaming server comprises a communications interface to receive and send communications over a network; a microprocessor coupled with the communications interface; and a memory coupled with and readable by the microprocessor and storing therein a set of instructions. The set of instructions, when executed by the microprocessor, causes the microprocessor to monitor player activity on a plurality of gaming devices; in response to a monitored player activity of a selected player complying with a set of promotional rules, assign a loyalty point award to the selected player, the loyalty point award being assigned independently of an outcome of a game on the plurality of gaming devices; receive a request to convert the loyalty point award into a selected cryptocurrency for transfer into a digital account associated with the selected player; determine that the selected player request complies with a set of conversion rules different from the set of promotional rules; in response to the determining, apply a first conversion ratio associated with the selected cryptocurrency to the loyalty point award to provide a converted amount of the selected cryptocurrency; and cause the digital account of the selected player to be updated to reflect the applying by decrementing a loyalty point balance of the selected player and incrementing a balance of the selected cryptocurrency.

In some embodiments, a gaming system comprises a display to render gaming information in a gaming session to a player; a user interface to receive player input; a communications interface that facilitates communications with the player; a microprocessor coupled with the display, user interface, and communications interface; and a computer memory coupled with the microprocessor. The computer memory comprises a microprocessor-executable set of instructions that, when executed by the microprocessor, causes the microprocessor to receive a request to convert loyalty points from game play by a selected player into a selected cryptocurrency for transfer into a digital account associated with the selected player, wherein the loyalty points are awarded independently of an outcome of the game play; determine, for the selected cryptocurrency, a corresponding set of account verification rules, wherein each cryptocurrency corresponds to a different set of account verification rules; require, as part of digital account verification, the selected player, using a private key of the digital account, to perform an activity set forth in the corresponding set of account verification rules; monitor for an activity performance; when the activity performance indicates that the selected player performed the activity successfully, determine that the selected player owns or is otherwise authorized to perform transactions involving the digital account; in response to the selected player owning or being authorized to perform transactions involving the digital account, determine that the selected player request complies with a set of conversion rules different from the sets of promotional rules and account verification rules; in response to the determination that the request complies with the set of conversion rules, apply to the loyalty points a first conversion ratio associated with the selected cryptocurrency to provide a converted amount of the selected cryptocurrency; cause the digital account of the selected player to be updated to reflect the applying by decrementing a loyalty points balance of the selected player and incrementing a balance of the selected cryptocurrency; and when the activity performance indicates that the selected player failed to perform the activity successfully, determine that the selected player does not own and is not authorized to perform transactions involving the digital account and thereafter deny the request of the selected player.

Additional features and advantages are described herein and will be apparent from the following Description and the figures.

### BRIEF DESCRIPTION OF THE SEVERAL VIEWS OF THE DRAWINGS

FIG. 1 is a block diagram of a gaming network in accordance with embodiments of the present disclosure;

FIG. 2 is a block diagram depicting a gaming device in accordance with embodiments of the present disclosure;

FIG. 3 is a block diagram depicting a gaming server in accordance with embodiments of the present disclosure;

FIG. 4 is a block diagram depicting a mobile device in accordance with embodiments of the present disclosure;

FIG. 5 is an illustrative data structure used in a cryptocurrency conversion record in accordance with embodiments of the present disclosure;

FIG. 6A is an illustrative data structure used in a player profile in accordance with embodiments of the present disclosure;

FIG. 6B is an illustrative data structure used in a cryptocurrency wallet in accordance with embodiments of the present disclosure;

FIG. 7 illustrates a series of mobile device displays rendering various screenshots in the loyalty point conversion process in accordance with embodiments of the present disclosure;

FIG. 8 illustrates a series of gaming device displays rendering various screenshots in the loyalty point conversion process in accordance with embodiments of the present disclosure;

FIG. 9 is a screenshot of a promotional balance conversion setup in accordance with embodiments of the present disclosure;

FIG. 10 is a screenshot of a promotional balance conversion setup in accordance with embodiments of the present disclosure;

FIG. 11A is a flow diagram depicting a method of converting loyalty points to cryptocurrency in accordance with embodiments of the present disclosure;

FIG. 11B is a flow diagram depicting a method of converting loyalty points to cryptocurrency in accordance with embodiments of the present disclosure;

FIG. 12 is a picket fence diagram depicting a method of converting loyalty points to cryptocurrency in accordance with embodiments of the present disclosure;

FIG. 13A is a flow diagram depicting a method of converting loyalty points to cryptocurrency in accordance with embodiments of the present disclosure; and

FIG. 13B is a flow diagram depicting a method of converting loyalty points to cryptocurrency in accordance with embodiments of the present disclosure.

### DETAILED DESCRIPTION

Embodiments of the present disclosure will be described in connection with a gaming device having a capability to convert loyalty points to cryptocurrency and vice versa. While certain embodiments of the present disclosure will reference the use of gaming devices, such as an Electronic Gaming Machine (EGM), Electronic Gaming Table (EGT), lottery vending machine, virtual gaming machine, or video gaming gambling machine (VGM), as a device that converts cryptocurrency, it should be appreciated that embodiments of the present disclosure can be used with any computer-controlled gaming device or collection of gaming devices or other devices controlled by a gaming server.

A “loyalty point” refers to points that can be earned through designated activities or loyalty point initiation events at a gaming establishment, which activities can be tracked by means of tracking usage of a virtual or physical player loyalty card or associated loyalty account. Such establishments include casinos, hotels where gaming activities are provided, stores where gaming activities are permitted, Internet-based gaming activities, and the like. Designated activities can include, but are not limited to, playing games or participating in gaming sessions, such as playing gaming machines, card games (such as blackjack, pai gow poker, baccarat and poker), table games (such as roulette, craps, and keno), lotteries, betting on public event outcomes, etc. and other predetermined gaming activities. Other patronage activities at gaming establishments may accrue loyalty points, such as purchases of goods and services at the casino. Loyalty points commonly represent a form of credit accrued for patronage. The points can be redeemed for a variety of goods or services (or translated to other forms of credit) within a gaming establishment or affiliated establishment.

Typically, a loyalty point award is independent of the outcome of the game or gaming session but is based on an amount of monetary expenditure, such as for wagers on a gambling machine, wagers on table games, spend at various establishments in a casino (e.g., spa, restaurants, night clubs, etc.), hotel, and the like. Loyalty points can be not only player loyalty points but also free play (extra credit, non-cashable credits, and the like), gift points, comp dollars and others. Some of these points may be visible to players, while some may be visible to only casino staff. Some points may only be able to be used to fund certain types of free or incentivized activity at certain locations (e.g., slot machines), while not supporting free or incentivized player activity at other locations (e.g., the spa). Some points may have expiration times, while others may not have any expiration.

Based on the number of points, the player can reach higher levels of the point-based loyalty program. Typically, the higher levels in the loyalty program feature better rewards. More points can be rewarded for playing certain types of games or gaming devices, e.g., a player might earn more points for playing casino games than slot games. The points can be redeemed for bonus cash or other perks. Some loyalty programs use gamification, where the player needs to complete certain missions, or activities, to access the benefits. The programs can require a player to swipe a loyalty or membership card at each transaction and use this transactional data (i.e., what games the player plays or what type of slot machines the player prefers) plus demographics to structure offers and rewards.

Loyalty points represent a liability for casinos and other gaming establishments as they can be redeemed by a player at any time. This liability may be reflected on the gaming establishment’s balance sheet in its financial statements. To manage this liability, especially for destination gaming establishments requiring player travel to use loyalty points, some gaming establishments may offer players the ability to convert some or all of these currencies to physical goods that the player may not have to purchase in person. The present disclosure is advantageous in that it provides a method for a gaming establishment operator to convert gaming establishment loyalty points into cryptocurrencies in order to offload gaming establishment loyalty liability.

A “cryptocurrency”, “crypto-currency”, or “crypto” is a collection of binary digital data which is designed to work as a medium of exchange wherein individual coin ownership records are stored in a ledger which is a computerized database using strong cryptography to secure transaction records, to control the creation of additional coins, and to verify the transfer of coin ownership. The validity of each cryptocurrency’s coins can be provided by a digital ledger (e.g., blockchain). A blockchain is a continuously growing list of records, called blocks, which are linked and secured using cryptography. Each block typically contains a hash pointer as a link to a previous block, a timestamp, and transaction data. The blockchain can be replaced by other cryptographically secured data structures such as a directed acyclic graph. Examples of cryptocurrency include Bitcoin, Ethereum, Cardano, Binance Coin, Tether, Solana, XRP, Dogecoin, Polkadot, Litecoin, Monero, and USD coin.

Validating a transaction in the digital ledger, or cryptocurrency mining, can take many forms. In many applications, the process of guessing a hash starts in a block header containing a block version number, a timestamp, a hash used in a previous block, a hash of the Merkle Root, a nonce, and a target hash. Determining which string to use as the nonce requires a significant amount of trial-and-error, as it is a random string. A validator must guess a nonce, append it to the hash of the current header, rehash the value, and compare the rehashed value to the target hash. If the rehashed value meets the predetermined criteria set forth in the target hash, which commonly requires the hash to be less than the target hash, then the block is added to the blockchain. Cycling through solutions to guess the nonce is referred to as a proof of work. As will be appreciated, proof of stake (PoS), by contrast, is a consensus algorithm under which randomly chosen validation nodes (validators) stake native tokens (staking) of the blockchain network to propose or attest new blocks to the current blockchain. A validator will receive rewards by successfully adding blocks to the blockchain. In proof of stake systems, a validator typically can only mine blocks up to the percentage of coin market cap that the validator owns or controls. While the present disclosure is discussed primarily with reference to Bitcoin, it is to be understood that it is applicable to any cryptocurrency framework, including Etherium, Litecoin, Tether and Monero. While Bitcoin uses the proof of work (nonce, hash computation, etc.), other cryptocurrencies use other proof of work algorithms, which generally involve performing one or more other intractable operations. Such operations are selected to be hard to reverse but easy to verify. Computing hashes on a block chain is an example of an intractable problem. Other cryptocurrencies may not involve a verification of a chain (list). It is further to be understood that, while the present disclosure is discussed primarily with reference to digital ledgers, it can be applied to a cryptocurrency based on the use of a directed acyclic graph to track cryptocurrency transactions.

Embodiments of the present disclosure will be described in connection with a gaming system that can interact with players to process cryptocurrency/loyalty point conversions while also being accessible to players for gaming sessions, such as operating gaming functions and displaying a game (e.g., slot or poker, sports wagering, and electronic table gaming).

In some embodiments, the gaming system can monitor player activity on multiple gaming devices and, in response to a selected player complying with a set of promotional rules, assign a loyalty reward to a digital account of the selected player. The gaming system can receive a request to convert the loyalty point reward into a selected cryptocurrency for transfer into a digital account associated with the selected player, determine that the selected player request complies with a set of conversion rules different from the set of promotional rules, and, in response, apply a first conversion ratio associated with the selected cryptocurrency to the loyalty point reward to provide a converted amount of the selected cryptocurrency, and cause the digital account of the selected player to be updated by decrementing a loyalty point reward balance of the selected player and incrementing a balance of the selected cryptocurrency.

In some embodiments, the gaming system can provide the selected player with a set of multiple loyalty point conversion options. Each loyalty reward conversion option can include conversion of the loyalty points into a respective type of cryptocurrency different from a type of cryptocurrency associated with a different loyalty point conversion option. One of the loyalty point conversion options can include a loyalty point conversion option to convert the loyalty points into the selected cryptocurrency. Each of the loyalty point conversion options in the set of loyalty point conversion options can have a respective conversion ratio different from a conversion ratio associated with a different loyalty point conversion option, and each respective conversion ratio can correspond to an expiration time after which the respective conversion ratio is no longer valid.

The cryptocurrency can be held in a crypto wallet at the gaming establishment or transferred to an external crypto account of the selected player. The wallet is a set of data structures that store a public and private key pair generated from a theoretical or random number being generated by a random or pseudorandom number generator and used with a length depending on the cryptocurrency’s algorithm requirements. The number is converted into a private key using the specific requirements of the cryptocurrency cryptography algorithm requirement. The public key acts as an addressable address to receive cryptocurrency and is generated from the private key using whichever cryptographic algorithm requirements are required. The private key is used by the account owner to prove account ownership and access, exchange, purchase, and sell digital assets, such as cryptocurrency, and is private to the owner, whereas the public key is shared to any third party to receive cryptocurrency from the account owner and send cryptocurrency to the account owner. The cryptocurrency is itself not in the wallet but is decentrally stored and maintained in a publicly available distributed digital ledger (e.g., blockchain) and can be derived from the wallet. The wallet can be deterministic (in which a single key is used to generate an entire string of key pairs) or non-deterministic (in which each key is randomly generated on its own accord and not seeded from a common key). A seed phase, or word phrase, that is an unencrypted form of the private key in dictionary word format that is simpler to remember than an encrypted cryptographic key in another string format can also be used to gain access to the wallet and associated keys and cryptocurrency.

The resort wallet of the gaming establishment or gaming system can use separate data structures to track cryptocurrency and cash currency or non-cryptocurrency balances and, in some embodiments to avoid transaction fees (which is generally a fractional share of cryptocurrency transferred). The latter tracking capability enables the gaming server to delay transferring the cryptocurrency until the actual transfer is made directly to a cryptocurrency wallet of the player. For example, updating the set of data structures associated with an account of the selected player to reflect an award comprises updating separate sets of cash balance and a cryptocurrency balance data structure to reflect cash awards and cryptocurrency awards, respectively. In some embodiments, the gaming server can update the digital ledger to reflect transfer of a portion of the reward to an electronic address associated with a cryptocurrency wallet of a selected player.

Stated differently, the resort wallet is a digital account that comprises data structures indicating, for each type of cryptocurrency, a total crypto balance shared by multiple players and including an indicator of how much of the crypto balance is to be allocated to each identified player. A public and private key pair that is common to all of the shares of the crypto balance allocated to the players. In contrast, the player’s own external digital wallet corresponds to a public and private key pair associated only with the selected player.

In other embodiments, the resort wallet comprises separate wallets for each of the players. This embodiment may, however, incur transaction fees for each cryptocurrency within the gaming system; that is, a cryptocurrency transfer from a player wallet maintained by the gaming establishment to another player’s wallet maintained by the gaming establishment or to a gaming establishment wallet would be posted on the digital ledger and therefore incur transaction fees. In contrast, the former embodiment can effect transfers within the resort wallet without posting on the digital ledger and incurring transaction fees.

In some embodiments, each cryptocurrency wallet corresponds to multiple different types of cryptocurrency or only one of the different types of cryptocurrency. In the latter, the gaming system or selected player would have multiple cryptocurrency wallets corresponding to multiple different types of cryptocurrency.

In some embodiments, conversion rules control the availability and features of the cryptocurrency conversion. For example, the set of conversion rules can require a minimum loyalty reward balance for conversion to occur to cover transaction fees.

When the digital account comprises the minimum loyalty reward balance, the applying of the conversion rules can occur automatically upon the detected occurrence of a predetermined event. The set of conversion rules can condition the conversion on one or more of an amount of game play by the selected player over a selected time interval, an amount of money spent by the selected player over the selected time interval on gaming and non-gaming offerings of the gaming establishment, occurrence of a game event, occurrence of a system event, and occurrence of a random event. For example, players who trigger a royal flush might be allowed to convert to Bitcoin or players who win a Lucky Coin event might be allowed to convert to Bitcoin. In some embodiments, the ability to perform a conversion is triggered by a sequence of events such as playing a series of games, triggering a series of events, or making a series of transactions at the gaming establishment. The set of conversion rules can require different categories of players to have different sets of loyalty reward conversion options.

In some embodiments, the conversion rules can restrict the destination account for receiving the converted cryptocurrency. The set of conversion rules, for instance, can permit the selected player to transfer the converted amount to a second digital account (e.g., the casino cryptocurrency wallet) but not a first digital account (e.g., the selected player’s external cryptocurrency wallet).

In some embodiments, the gaming system can convert cryptocurrency to loyalty points. For example, the gaming system can receive a further request from the selected player to convert the converted amount of the selected cryptocurrency into loyalty points, determine that the selected player request complies with the set of conversion rules, in response to the determining, further apply a second conversion ratio different from the first conversion ratio, and the second conversion ratio being associated with the selected cryptocurrency, to the converted amount of the selected cryptocurrency to provide a converted amount of the loyalty points, and cause the digital account of the selected player to be updated to reflect the further applying by decrementing a balance of the selected cryptocurrency and incrementing a loyalty point balance.

In either type of conversion to or from cryptocurrency, money laundering and financial fraud is a concern. How to address this concern is complicated by the different features and requirements of the different types of cryptocurrencies offered to players as conversion options and the need to authenticate player ownership of the destination wallet. For example, an owner of a Bitcoin wallet is able to use his or her private key to transfer cryptocurrency only. Other cryptocurrencies can use private keys more broadly for the exchange, purchase, and sale of digital assets and supporting narrowly targeted applications. Some cryptocurrencies permit the account owner to sign smart contracts that are digitally signed in the same way a cryptocurrency transaction is signed. Some wallets require not one but multiple parties to sign the transaction with different private keys.

To prevent laundering and fraud for these different types of cryptocurrency, the gaming system can perform digital account verification by determining, for a selected cryptocurrency, a corresponding set of account verification rules (each cryptocurrency corresponds to a different set of account verification rules), requiring, as part of digital account verification, the selected player to perform an activity set forth in the corresponding set of account verification rules, monitoring a communications interface for an activity performance, when the activity performance indicator indicates that the selected player performed the activity successfully (or an activity performance indicator has a first value), determining that the selected player owns the digital account and thereafter performing the requested conversion from or to cryptocurrency and/or transfer of cryptocurrency from the casino or resort wallet to the player’s cryptocurrency wallet, and when the activity performance indicates that the selected player failed to perform the activity successfully (or the activity performance indicator has a different second value), determining that the selected player does not own the digital account and thereafter not performing the requested conversion or transfer.

By way of illustration, to verify that a destination wallet is owned by the selected player for cryptocurrencies such as Bitcoin that is designed for maintaining a decentralized payment network, the selected player could be required to submit a blank or transfer of zero crypto funds, or some trivial amount of crypto funds, between a destination account associated with the player’s wallet and an account associated with the casino’s cryptocurrency wallet within a certain timeframe. The casino’s cryptocurrency wallet (e.g., a component of or integrated with a resort wallet), or a cryptocurrency conversion function would then allow the player to transfer converted crypto funds to the identified destination account once the posted transaction has been properly verified (consensus) by the quorum of miners or validators on the associated blockchain.

For other cryptocurrencies, such as Ethereum that is designed for maintaining a decentralized payment network and storing computer code which can be used to power tamper-proof decentralized financial contracts and applications, the selected player can verify that he or she owns the destination account by taking some random data or a random message generated by the casino’s cryptocurrency wallet application or the cryptocurrency conversion function (such as by a random number generator or pseudorandom number generator) and sign that data with the private key tied to the desired destination account associated with the player’s wallet. The signed data is posted on the blockchain to the account associated with the player’s wallet and when properly signed as shown by the public key of the player’s wallet establishes ownership of the account to the casino’s cryptocurrency wallet application or the cryptocurrency conversion function.

For other cryptocurrencies, such as Cardano, a simplified smart contract provided by the casino wallet or the crypto conversion service can be digitally sent to the player’s cryptocurrency wallet application and signed and posted by the player on the blockchain to the account associated with the player’s account to establish ownership of the account to the casino’s cryptocurrency wallet application or the cryptocurrency conversion function. As will be appreciated, a smart contract is a computer program or a transaction protocol which is intended to automatically execute, control or document legally relevant events and actions according to the terms of a contract or an agreement. Similar to a transfer of value on a blockchain, deployment of a smart contract on a blockchain occurs by sending a transaction from a wallet for the blockchain. The transaction includes the compiled code for the smart contract as well as a special receiver address. That transaction must then be included in a block that is added to the blockchain, at which point the smart contract’s code will execute to establish the initial state of the smart contract. Smart contracts on a blockchain can store arbitrary state and execute arbitrary computations. Posting of the smart contract on the blockchain by the player establishes his or her ownership of the account associated with the destination wallet.

In other cryptocurrencies, homomorphic encryption can be employed that permits the player’s wallet to perform selected computations on encrypted data provided by the casino wallet or the cryptocurrency conversion function without first decrypting it. These resulting computations are left in an encrypted form and either signed by the player and posted on the blockchain or returned to the casino wallet or the cryptocurrency conversion function. When decrypted using the player’s public key and original encryption key or its counterpart decryption key, result in an identical output to that produced had the operations been performed on the unencrypted data. Matching results confirm ownership by the player of the destination account or wallet. By using homomorphic encryption techniques to store data over the blockchain, no significant changes in the blockchain properties are made and the data on the blockchain can be encrypted to maintain the privacy of the underlying data.

Maintaining different account verification rules for different cryptocurrency can prevent laundering and fraud for any cryptocurrency selected by the player. When the activity required for account verification is performed successfully by the player within a specified time interval of sending the request or other information to the player or his or her wallet, the player’s ownership of the account is verified. The casino’s cryptocurrency wallet (a component of or integrated with resort wallet), or the crypto conversion Function would then allow the player to transfer converted funds to the identified destination account once the posted transaction has been properly verified (consensus) by the quorum of miners or validators on the associated blockchain. When the activity required for account verification is not performed either within the specified time interval of sending the request or other information to the player or his or her wallet or even when performed timely is not performed successfully, the player’s ownership of the account is not verified.

Other rules may also be employed alone or in addition to the rules above to prevent or disincentivize money laundering and fraud. For example, the conversion rules applied by the gaming establishment might can apply conversion limits to a player. For example, a player might be able to convert only X amount of loyalty points to cryptocurrency within a specified period of time (e.g., per day, per week, per month, etc.). The rule could be applied only to one cryptocurrency and not others or across multiple cryptocurrencies. In another embodiment, the casino may limit the amount of loyalty points to convert to cryptocurrency on a per destination account basis. For example, the casino may only allow the transfer of 0.2 BTC per day to a single destination account.

The player may use a user interface on a gaming device, gaming server, kiosk, or the player’s own mobile device to perform the conversion of loyalty points to cryptocurrency or vice versa. In one embodiment, the gaming establishment’s mobile app may have a feature for the player to convert a casino loyalty point maintained by a patron manager into cryptocurrency. The player may be offered a conversion ratio between the loyalty points and the cryptocurrency. The player will also have to identify the cryptocurrency wallet which he or she desires to transfer the cryptocurrency to on the blockchain. In another embodiment, such a workflow could be implemented on a website. Alternatively, the player could begin the action at the gaming device, such as an Electronic Gaming Machine (EGM), Electronic Gaming Table (EGT), lottery vending machine, virtual gaming machine, or video gaming gambling machine (VGM) or at a kiosk.

In some embodiments, the gaming system controls the conversion, by the cryptocurrency conversion function that is typically a component of or integrated with the patron manager and/or resort wallet and supports configuration of the conversion ratios from one or more loyalty point balance types to one or more cryptocurrencies.

In some embodiments, not all players at the casino have access to the conversion feature. Performing transactions on the digital ledger may be expensive in some situations (e.g., the transaction fee was $11.23 on May 16, 2021), so the gaming establishment may restrict the conversion feature to players having large point balances and/or of high value to the gaming establishment. As a result, the feature may only be available if the player’s rank in the gaming establishment is at a certain level. For example, the gaming establishment may only offer the ability to convert loyalty points (e.g., comp dollars) to cryptocurrency if the player is a silver tier player or better (silver, gold, or platinum), but may exclude bronze players. In some embodiments, the gaming establishment may support conversions to cryptocurrency from loyalty points into the player’s crypto wallet inside of his or her resort wallet when the player is of a lower tier or loyalty rank and may only support conversions of loyalty points to cryptocurrency in an external wallet if the player is of a higher tier or rank. Converting points to cryptocurrency held in the player’s cryptocurrency wallet of his or her resort wallet may require lower fees if the gaming establishment, or the third party backer of the gaming establishment’s cryptocurrency wallet of its resort wallet, have that cryptocurrency already on hand or in escrow for other reasons. In some embodiments, the player mobile application or service window shows the player his or her cryptocurrency balance and any changes in value.

In some embodiments, the player loyalty status (e.g. silver, gold, bronze) determines which cryptocurrencies are available to the player for conversion. For example, gold level players might be allowed to convert loyalty points to Bitcoin, while silver players can only convert loyalty points to Ethereum, etc. Or gold level players can convert to Bitcoin and Ethereum while silver players can only convert loyalty points to Ethereum. The conversion schedule might change over time based on the popularity or price changes in the cryptocurrencies. For example, Ethereum may become more popular or have greater price changes relative to dollars or other local currency so the gold level loyalty tier is given access to convert to Ethereum (and possibly Bitcoin), while the silver loyalty tier level is given access to convert loyalty points to Bitcoin only.

In some embodiments, the player might convert some or all of the cryptocurrency in the resort wallet to the local currency (such as dollars) for casino play.

In some embodiments, the player might convert some or all of the cryptocurrency into traditional rewards such as player points, free shows, free meals, free play, gift points, discounts, comp dollars, etc. For example, a player might convert 1,000 points to 1 Bitcoin (BTC) because the conversion rate is 1,000 points for 1 BTC. Later the conversion rate changes such that the 1 BTC is worth 10,000 points and the player can convert back to points from BTC. Thus, the player has been able to participate in the appreciation of the cryptocurrency.

In another embodiment, the gaming establishment may only offer the ability to convert loyalty points to cryptocurrency if the player performs some minimum loyalty point conversion transaction size. This minimum threshold may help ensure that the value accrued to the player is high enough to cover the underlying transaction fees. This limit may be static or based upon the current transaction fees associated with one or more blockchains.

While player triggered transfers of a loyalty points into one or more cryptocurrencies can be based upon receipt of a player request (one request per transaction), the player can configure the gaming system to automatically initiate the conversion of loyalty points to cryptocurrency upon the occurrence of one or more selected events. In one embodiment, the player can configure the conversion to happen after the end of his or her play session. In another embodiment, the player can configure the conversion to happen nightly, or at the end of his or her casino trip, once his or her accumulated loyalty balance hits some minimum threshold, or any other appropriate conversion triggering event. For example, the player may elect to automatically convert his or her earned player loyalty points after the end of a play session at an EGM. Automated conversion might be tied to being assigned a player loyalty status or achieving a predetermined play level or rank or tier of performance.

In some embodiments, the player may only use cryptocurrencies in his or her resort wallet to purchase or redeem comps, such as free or discounted meals, free or discounted shows, resort amenities or services, and the like. For example, a player may only be able to redeem 0.01 BTC for a free show ticket and not use loyalty points directly. In other words, loyalty points may be an intermediary currency in some instances, and a conversion to a cryptocurrency may be required to perform certain casino loyalty transactions.

In some embodiments, some player, game, or system features may be enabled only for players with cryptocurrency balances or cryptocurrency balances of a certain denominations such as Bitcoin. For example, a Lucky Coin trigger might only be awarded to a player on the casino floor that has some cryptocurrency of a specific type in his or her resort wallet.

Gaming devices can notify players when a conversion from loyalty points to cryptocurrency or vice versa and/or concomitant transfer to the gaming system’s resort wallet or the player’s wallet is in process or completed. The player could be notified via some communication mechanism, such as via an SMS/text message, in-app notification, e-mail, phone call, etc.

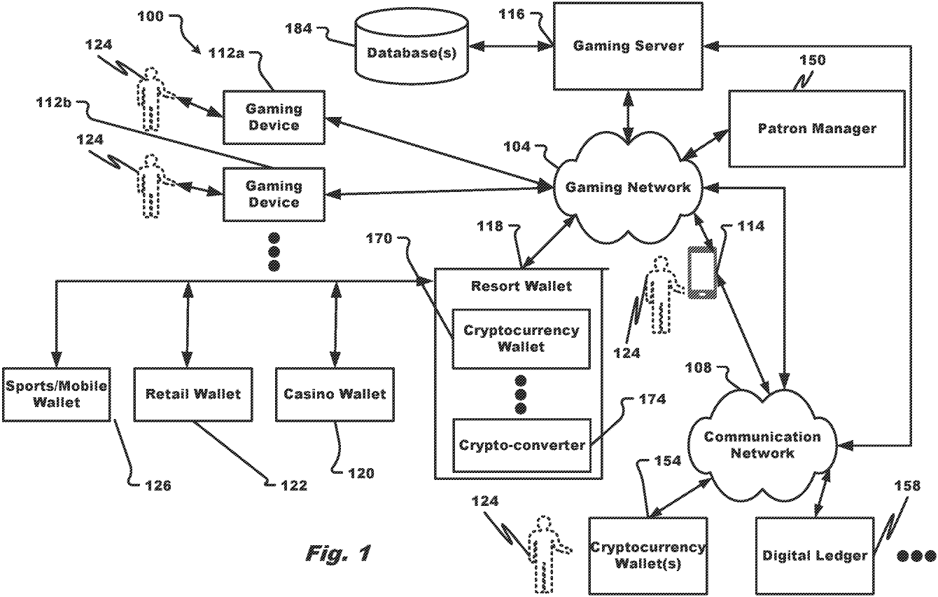

With reference initially to FIG. 1, details of an illustrative gaming system 100 will be described in accordance with at least some embodiments of the present disclosure. The components of the gaming system 100, while depicted as having particular instruction sets and devices, is not necessarily limited to the examples depicted herein. Rather, a network according to embodiments of the present disclosure may include one, some, or all of the components depicted in the system 100 and does not necessarily have to include all of the components. For instance, the components may be distributed amongst a plurality of servers and/or gaming devices (e.g., an EGM, etc.) without departing from the scope of the present disclosure. The illustration of a single central gaming server 116 is for ease of discussion and should not be construed as limiting embodiments of the present disclosure to a single-server architecture.

The gaming system 100 is shown to include a gaming network 104 and a communication network 108. The gaming network 104 may correspond to a distributed set of devices that interconnect and facilitate machine-to-machine communications between one or multiple gaming devices 112a, b, ..., a mobile device 114, a resort wallet 118 and associated casino wallet 120, retail wallet 122, and sports/mobile wallet 126, patron manager 150, and the gaming server 116. The communication network 108 may correspond to a distributed set of devices that interconnect and facilitate machine-to-machine communications between the components of the gaming system 100 and external components including the mobile device 114, cryptocurrency wallet(s) 154 and digital ledger 158. In some embodiments, the gaming network 104 and communication network 108 may correspond to different networks administered and/or maintained by different entities. In such a scenario, one or more of a gateway, firewall, or similar network border device may reside between the gaming network 104 and the communication network 108 (e.g., to maintain security preferences/settings of each network). In another possible scenario, the gaming network 104 and communication network 108 may correspond to the same or similar network. As a non-limiting example of the second scenario, the gaming network 104 and communication network 108 may both correspond to a distributed Internet Protocol (IP)-based communication network, such as the Internet.

The gaming network 104 and communication network 108 may include any type of known communication medium or collection of communication media and may use any type of protocols to transport messages between devices. As some non-limiting examples, the gaming network 104 may correspond to a WAN or LAN in which the plurality of gaming devices 112a, b, ... are configured to communicate with the gaming server 116 using devices that are owned and administered by the same entity that administers security settings of the gaming devices 112a, b, ... As such, the gaming network 104 may be considered a secure or trusted network.

The communication network 108, in some embodiments, may also include a WAN or LAN. Alternatively or additionally, the communication network 108 may include one or more devices that are not administered by the same entity administering the gaming devices 112a, b, .. . Thus, the communication network 108 may be considered an untrusted or unsecure network from the perspective of the gaming network 104. The Internet is an example of the communication network 108 that constitutes an IP network consisting of many computers, computing networks, and other communication devices located all over the world, which are connected through many telephone systems and other means. Other examples of the communication network 108 include, without limitation, a standard Plain Old Telephone System (POTS), an Integrated Services Digital Network (ISDN), the Public Switched Telephone Network (PSTN), a cellular network, and any other type of packet-switched or circuit-switched network known in the art. In some embodiments, the communication network 108 may be administered by a Mobile Network Operator (MNO) whereas a casino entity may administer the gaming network 104.

It should be appreciated that the gaming network 104 and/or communication network 108 need not be limited to any one network type, and instead may be comprised of a number of different networks and/or network types. Moreover, the gaming network 104 and/or communication network 108 may comprise a number of different communication media such as coaxial cable, copper cable/wire, fiber-optic cable, antennas for transmitting/receiving wireless messages, wireless access points, routers, and combinations thereof.

In some embodiments, the gaming devices 112a, b, ... may be distributed throughout a single property or premises (e.g., a single casino floor) or the gaming devices 112a, b, ... may be distributed among a plurality of different properties. In a situation where the gaming devices 112 a, b, ... are distributed in a single property or premises, the gaming network 104 may include at least some wired connections between network nodes (e.g., a LAN or multiple LANs). As a non-limiting example, the nodes of the gaming network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming devices 112 a, b, ... may utilize the same or different types of communication protocols to connect with the gaming network 104. It should also be appreciated that the gaming devices 112 a, b, ... may or may not present the same type of game to a player 124. It should be appreciated that a gaming device 112 a, b, ... may correspond to one example of a gaming device. It should also be appreciated that the functions and features described in connection with a gaming device 112 a, b, ... may be provided in any other type of gaming device without departing from the scope of the present disclosure.

In some embodiments, the gaming devices 112 a, b, ... may be configured to communicate with a centralized management server in the form of the central gaming server 116. The central gaming server 116 may be configured to centrally manage games of chance, games of skill, or hybrid games of chance/skill played at the gaming devices 112 a, b, ... (e.g., slot games), enable execution of a different game (e.g., a card game), monitor player 124 activity at the gaming devices 112 a, b, ..., track player 124 association with a gaming device 112 (such as loyalty point initiation events and other gaming events), facilitate communications with players 124 via the gaming devices 112 a, b, ..., and/or perform any other task in connection with games played by a player 124 at gaming devices.

It should be appreciated that the central gaming server 116 may or may not be co-located with the gaming devices 112. Thus, one or more gaming systems 112 may communicate with the gaming server 116 over a WAN, such as the Internet. In such an event, a tunneling protocol or Virtual Private Network may be established over some of the communication network 108 to ensure that communications between a gaming device 112 and a remotely-located gaming server 116 are secured.

FIG. 1 also depicts the possibility of some personal gaming mobile devices 114 (e.g., smart phones, tablet computers, etc.) being paired with a gaming device 112, thereby enabling communications to flow between the personal gaming mobile device on the one hand and the gaming device 112 on the other. This communication may utilize a proximity-based communication protocol, such as Bluetooth, BLE, NFC, WiFi, etc. One or more personal gaming devices of the player 124 may not necessarily be paired with a gaming device 112, but such personal gaming devices may still be configured to communicate with the central gaming server 116 via the communication network 108. Communications between the gaming device 112 and personal gaming mobile device may facilitate any number of combinations of gameplay opportunities.

The central gaming server 116 is in communication, via the gaming network 104, with one or more databases 184. The databases 184 may be configured to store one or multiple data structures (which can include the resort wallet 118, casino wallet 120, retail wallet 122, and sports/mobile wallet 126) that are used in connection with interactive gaming activities of players 124 and the gaming system 100. The databases can use any database model and compatible database management system. Examples of database models include relational databases, object-oriented databases, and non-relational databases, such as NoSQL and NewSQL databases.

In various embodiments, a gaming establishment fund management function in the gaming server 116 that includes one or more cashless wagering systems that are each associated with or otherwise maintain one or more cashless wagering accounts. In certain embodiments, the gaming establishment fund management function includes a first cashless wagering system that maintains a first cashless wagering account, in which a player utilizes a mobile device application or app running on a mobile device to facilitate the electronic transfer of any funds between the first cashless wagering account and a gaming device 112. For example, as seen in FIG. 1, a resort wallet 118 or enterprise wallet includes or is otherwise in communication with a sports/mobile wallet 126 (i.e., a first cashless wagering account maintained by a first cashless wagering function) accessible via the mobile device 114 running a mobile device application as described herein.

In certain embodiments, the gaming establishment fund management system additionally or alternatively includes a second cashless wagering function that maintains a second cashless wagering account associated with a physical instrument, such as a player issued magnetic striped card. In these embodiments, a player utilizes the physical instrument (e.g., via inserting the card into a player tracking unit associated with a gaming device) to facilitate the electronic transfer of any funds between this second cashless wagering account and the gaming device. Continuing with the example, as seen in FIG. 1, the resort or enterprise wallet 118 also includes or is otherwise in communication with a casino wallet 120 (i.e., a second cashless wagering account maintained by a second cashless wagering function) accessible via a physical instrument, such as a player issued magnetic striped card associated with the second cashless wagering function or a mobile device 114 associated with the second cashless wagering function.

In various embodiments, in addition to or an alternative of maintaining one or more cashless wagering accounts via one or more cashless wagering functions, the gaming establishment fund management function includes one or more gaming establishment retail functions that each maintain one or more gaming establishment retail accounts. Such a gaming establishment retail account (i.e., a gaming establishment retail wallet 122) integrates with various retail point-of-sale systems throughout the gaming establishment to enable players to purchase goods and/or services via the player’s gaming establishment retail account. Continuing with this example, as seen in FIG. 1, the resort or enterprise wallet 118 further includes or is otherwise in communication with the retail wallet 122 (i.e., a gaming establishment retail account maintained by a gaming establishment retail function) accessible via a point-of-sale terminal associated with a gaming establishment.

In various embodiments, the resort wallet 118 comprises one or more cryptocurrency wallet(s) 170 having a private and public key pair associated with the gaming establishment and comprising a cryptocurrency balance for an associated cryptocurrency type and a crypto-converter 174 that may alternatively reside in the gaming server 116 and manages conversion rates from one or more casino balance types to one or more cryptocurrencies, applies account verification rules to verify, for an identified external cryptocurrency wallet that a player attempting to use the wallet is authorized to effect transactions to and from the wallet, and applies conversion rules (discussed below) to convert cryptocurrency to loyalty points and loyalty points to cryptocurrency.

In certain embodiments, the resort wallet 118 account associated with a player includes one or more gaming establishment cryptocurrency accounts associated with respective cryptocurrency blockchain networks. For example, the resort wallet 118 associated with the player can include a gaming establishment bitcoin account associated with the player and a gaming establishment Ethereum account associated with the player.

The gaming server 116, gaming devices 112, mobile device 114, and resort wallet 118 are in communication, via communication network 108, with one or more player owned cryptocurrency wallet(s) 154 and digital ledger 158 (e.g., blockchain). The digital ledger 158 is commonly a distributed ledger (also called a shared ledger or distributed ledger technology or DLT) that is a consensus of replicated, shared, and synchronized digital data geographically spread across multiple spatial locations. Unlike a centralized database, there is commonly no central administrator. The digital ledger 158 can employ Replicated Journal Technology, since the information is replicated in the nodes containing a full copy of the information and the information in the blocks is included in timely order, more in the form of an accounting journal than as an accounting ledger. Typically, the digital ledger 158 is a blockchain distributed ledger. The digital ledger 158 may be permissioned or permissionless and employ one or more consensus algorithms, e.g., proof of work, proof of stake, hybrids thereof, and hashgraph. The digital ledger 158 is commonly minable (one can claim ownership of new coins contributing with a node) and can be a non-blockchain DLT that can be in the form of a distributed cryptocurrency. While blockchain requires global consensus across all nodes, a non-blockchain DLT can achieve consensus without having to validate across the entire blockchain.

Thus, it should be appreciated that in this embodiment, the gaming establishment cryptocurrency wallet 170 (and/or the gaming establishment fund management function) is in communication with each of the respective external digital ledgers 158 for which the gaming establishment cryptocurrency wallet 170 includes a corresponding gaming establishment cryptocurrency account. Moreover, to facilitate the transferring of cryptocurrency between an external cryptocurrency wallet 154 and the gaming establishment cryptocurrency wallet 170 associated with the player and vice versa, the gaming establishment cryptocurrency wallet 170 (and/or the gaming establishment fund management function) creates and registers (as necessary) the respective gaming establishment cryptocurrency wallet 170 with the corresponding external digital ledger 158. It should be appreciated that in various embodiments, a person may not need to “register” an account with his or her external digital ledger 158. For example, in various embodiments, an account number for a cryptocurrency account is the public key associated with the cryptocurrency account. In certain such embodiments, a transaction request requesting a transfer of cryptocurrency funds is made by posting the transaction request to the digital ledger 158 using the public key and a person can only access those funds when the provide the corresponding private key.

In general, to transfer funds between a first cryptocurrency account and a second cryptocurrency account, a transaction request is created and submitted to the respective cryptocurrency digital ledger 158 by the cryptocurrency wallet (and/or the mobile device application) initiating the funds transfer. The transaction request includes (amongst other information) (1) a source account identifier (e.g., a public key of a source wallet) (2) a destination account identifier (e.g., a public key of a destination wallet), (3) a transfer type identifier (i.e., a deposit (or transfer-in) or a withdrawal (or transfer-out), and (4) a transfer amount. That is, to transfer cryptocurrency funds to a player’s wallet 154, the gaming system provides (1) a source account identifier associated with the cryptocurrency wallet 170 of the gaming system, (2) a destination account identifier associated with the player’s cryptocurrency wallet 154, (3) deposit (or transfer-in) event identifier, and (4) the transfer amount. It should be appreciated that the cryptocurrency wallet (and/or the mobile device application) initiating the funds transfer typically provides the source account identifier and/or the destination account identifier. As will be appreciated, the specific details of the general steps vary from cryptocurrency to cryptocurrency; therefore, each cryptocurrency requires a specific protocol to be performed to effectuate a cryptocurrency transfer between the source and destination wallets.

In certain embodiments, the player 124 initiates a transfer from a gaming establishment fund management account to the player’s external cryptocurrency account by providing the destination account identifier associated with the external cryptocurrency account. For example, via the mobile device application running on his or her mobile device, the player enters his or her external cryptocurrency account public key. In some embodiments, the player enters the destination account identifier associated with his or her external cryptocurrency account via a gaming establishment web site, a kiosk, an EGM, or a gaming establishment club desk. In some embodiments, the player can also select information associated with an account he or she previously registered, used, or otherwise provided.

The gaming system 100 can include a patron manager 150 that manages the award of loyalty points and balance of players’ loyalty points accounts. Typically, the patron manager 150 monitors gaming events of players on gaming devices 112a, b, ... and changes in the balance of the resort wallet 118, casino wallet 120, retail wallet 122, and sports/mobile wallet 126, and other player transactions with the gaming establishing or casino and, applying promotional rules, increments or decrements a player’s loyalty point balance in the resort wallet 118. In some embodiments, the patron manager owns the loyalty point balance. The loyalty point balance is not stored in the resort wallet 122.

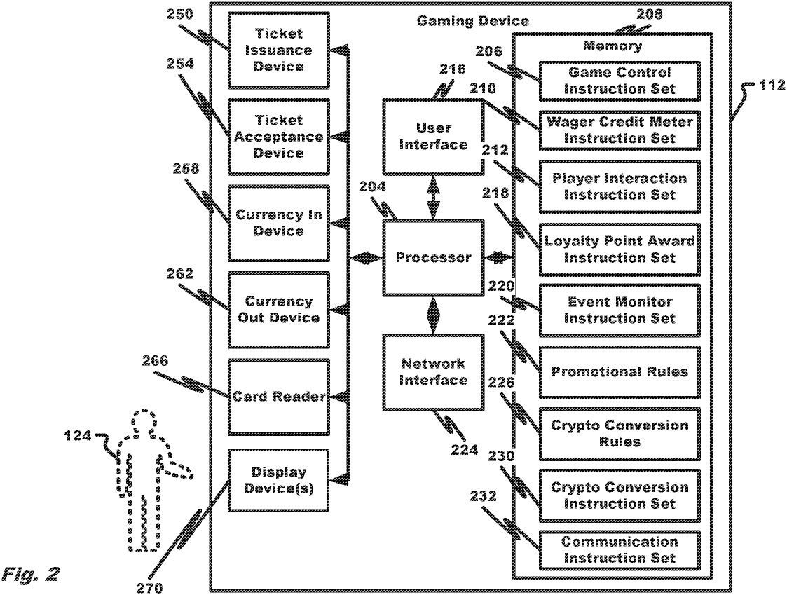

With reference to FIG. 2, additional details of the components that may be included in a gaming device 112 will be described in accordance with at least some embodiments of the present disclosure.

A gaming device 112 may correspond to a portable or non-portable device used for executing a gaming application or multiple different gaming applications without departing from the scope of the present disclosure. Non-limiting examples of a gaming device 112 include an EGM, a VGM, EGT, EGT player station, VR gaming machine, AR gaming machine, a mobile communication device (e.g., a smartphone, laptop, wearable device, etc.), a laptop, a PC, etc. The illustrative gaming device 112 depicted herein may include a support structure, housing or cabinet, which provides support for a plurality of displays, inputs, controls and other features of a conventional gaming machine. In some embodiments, a player 124 plays gaming device 112 while sitting, however, the gaming device 112 is alternatively configured so that a player can operate it while standing, moving, or sitting. The illustrated gaming device 112 can be positioned on the floor but can be positioned alternatively (i) on a base or stand, (ii) as a pub-style table-top game, (iii) as a stand-alone computational device on the floor of a casino with other stand-alone computational devices, or (iv) in any other suitable manner. The gaming device 112 can be constructed with varying cabinet and display configurations.

The gaming device 112 is shown to include a processor 204, memory 208, a network interface 224, and a user interface 216.

In some embodiments, the processor 204 may correspond to one or many microprocessors, CPUs, microcontrollers, Integrated Circuit (IC) chips, or the like. For instance, the processor 204 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 204 may be provided as a microcontroller, microprocessor, Central Processing Unit (CPU), or plurality of microprocessors that are configured to execute the instructions sets stored in memory 208. In some embodiments, the instruction sets stored in memory 208, when executed by the processor 204, may enable the gaming device 112 to provide game play functionality.

The nature of the network interface 224 may depend upon whether the network interface 224 is provided in cabinet- or player station-style gaming device 112 or a mobile gaming device 112. Examples of a suitable network interface 224 include, without limitation, an Ethernet port, a USB port, an RS-232 port, an RS-485 port, a NIC, an antenna, a driver circuit, a modulator/demodulator, etc. The network interface 224 may include one or multiple different network interfaces depending upon whether the gaming device 112 is connecting to a single gaming network 104 or multiple different types of gaming networks 104. For instance, the gaming device 112 may be provided with both a wired and wireless network interface 224 without departing from the scope of the present disclosure.

The user interface 216 may include a combination of user input devices and user output devices. For instance, the user interface 216 may include a display screen, speakers, buttons, levers, a touch-sensitive display, or any other device that is capable of enabling player 124 interaction with the gaming device 112. The user interface 216 may also include one or more drivers for the various hardware components that enable player 124 interaction with the gaming device 112.

The memory 208 may include one or multiple computer memory devices that are volatile or non-volatile. The memory 208 may include volatile and/or non-volatile memory devices. Non-limiting examples of memory 208 include Random Access Memory (RAM), Read Only Memory (ROM), flash memory, Electronically-Erasable Programmable ROM (EEPROM), Dynamic RAM (DRAM), etc.

The memory 208 may be configured to store the instruction sets depicted in addition to temporarily storing data for the processor 204 to execute various types of routines or functions. The instruction sets can enable user interaction with the gaming device 112 and game play at the gaming device 112. Examples of instruction sets that may be stored in the memory 208 include a game control instruction set 206, wager credit meter instruction set 210, player interaction instruction set 212, loyalty point award instruction set 218, event monitor instruction set 220, promotional rules 222, cryptocurrency conversion rules 226, cryptocurrency conversion instruction set 230, and communication instruction set 232. In addition to the instruction sets, the memory 208 may also be configured to store a random number generator or pseudorandom number generator (not shown) that is used by the game control instruction set 206, for example, to provide game outputs and the cryptocurrency conversion instruction set 230, for example, to determine player’s eligibility to exchange loyalty points for cryptocurrency.

In some embodiments, one or more of the components listed above, such as the loyalty point award instruction set and promotional rules instruction set, would likely be implemented in a System Management Information Base (“SMIB”) device and not natively in an Electronic Gaming Machine (“EGM”) (or gaming device). Some of the components may be partly or entirely located on the system-side. For example, the loyalty point award instruction set may be implemented as an SMIB function or natively in the EGM hardware and/or software.

In some embodiments, the game control instruction set 206, when executed by the processor 204, may enable the gaming device 112 to facilitate one or more games with the player(s) 124. In some embodiments, the game control instruction set 264 may include subroutines that receive electronic messages from player(s) and others comprising an indication of consideration (e.g., a wager, mini wager, side wager, etc.) for occurrence of a predicted level of player performance in the game, subroutines that stream a video of the game to gaming and personal gaming devices 112, 114 of other non-players or third parties, subroutines that create, maintain and update player profiles of the player(s) to the game, subroutines that generate, such as by a random number generator or pseudorandom number generator, an outcome of the game, subroutines that alter, modify, or select game or display operations or functions in response to loyalty point awards and cryptocurrency exchanges with players, subroutines that calculate whether an outcome of the game has resulted in a win or loss during the game, subroutines for determining winnings and award payouts for the player(s) and others in the event of a win, subroutines for exchanging communications with another device, such as another gaming device 112 or gaming server 116, and any other subroutine useful in connection with facilitating game play at the gaming device 112.

The wager credit meter instruction set 210, when executed by the processor 204, may enable the gaming device 112 to facilitate a tracking of activity at the gaming system 100. In some embodiments, the wager credit meter 210 may be used to store or log information related to various player 124 activities and events that occur at the gaming device 112. The types of information that may be maintained in the wager credit meter instruction set 210 include, without limitation, player information, available credit information, wager amount information, and other types of information that may or may not need to be recorded for purposes of accounting for wagers placed at the gaming device 112 and payouts made for a player 124 during a game of chance or skill played at the gaming device 112. In some embodiments, the wager credit instruction set 210 may be configured to track coin in activity, coin out activity, coin drop activity, jackpot paid activity, bonus paid activity, credits applied activity, external bonus payout activity, ticket/voucher in activity, ticket/voucher out activity, timing of events that occur at the gaming device 112, and the like. In some embodiments, certain portions of the wager credit meter instruction set 210 may be updated in response to outcomes of a game of chance or skill played at the gaming device 112. In some embodiments, the gaming device 112 does not include a wager credit meter instruction set 210.

The player interaction instruction set 212 and event monitor instruction set 220, when executed by the processor 204, detect player activity at the gaming device 112 and notifies the gaming server 116 of an instance of detected player 124 interaction, a type of player 124 interaction detected, and a timestamp associated with the player 124 interaction and enable the gaming device 112 to monitor operations of components of the gaming system 100 in response to interaction with players. The player gaming server 116 can use this input from the gaming device to determine loyalty point awards and determine a player’s eligibility for exchanging cryptocurrency and loyalty points, such as detecting a gaming event that enables the player to initiate an exchange. Types of player interaction with the gaming device 112 can comprise, for example, physical contact of an input of the gaming device by a player 124 and/or a current credit balance maintained by the credit meter instruction set 210 associated with the gaming device 112.

The loyalty point award instruction set 218, when executed by the processor 204, applies the promotional rules 222 to the monitored operations to reward loyalty points to eligible players. The loyalty point award instruction set 218 further causes the processor 204 to increment and decrement loyalty point award balances for eligible players. As noted, these functions can also be performed by the patron manager 150 independently of the gaming device or as part of the gaming server 116 as discussed below. For example, player 124 can be deemed to be eligible for loyalty points based upon amount of game play, type of game played (e.g., slots, blackjack, keno, etc.), amount of money spent or bet on game play, occurrence of a series of events or transactions involving a selected player at the game establishment, occurrence of a predetermined game event or sequence of events during one or more games (e.g., occurrence of a lucky coin event), occurrence of a system event (an event that is independent of a particular player’s game play but involving multiple gaming devices or players (e.g., the game establishment realizing a determined threshold of gaming activity throughout the gaming system, occurrence of a determined time of day or day of week, and the like), and/or occurrence of a random event generated by the random number generator or pseudo random number generator (e.g., output of a predetermined random number entitles all players of a selected rank or class (e.g., gold or silver players) but not players of another rank or class (e.g., silver) to receive and loyalty points). When random events are employed, a lookup table can map a predetermined event against a random or pseudorandom number or range of random or pseudorandom numbers. A given random or pseudorandom number therefore can yield a corresponding event. The processor 204 notifies the player 124 that he or she has received the loyalty point award, such as by sending a notification via a portable communication device of the player 124, rendering on a display the award notification and activating lights and playing sounds to congratulate the player 124 for the award.

The cryptocurrency conversion instruction set 230, when executed by the processor 204, applies the cryptocurrency conversion rules 226 to the monitored operations to determine player eligibility for cryptocurrency and loyalty point exchanges and to initiate the conversions for eligible players. For example, player 124 can be deemed to be eligible for the exchange based upon amount of game play, type of game played (e.g., slots, blackjack, keno, etc.), amount of money spent or bet on game play, occurrence of a series of events or transactions involving a selected player at the game establishment, occurrence of a predetermined game event or sequence of events during one or more games (e.g., occurrence of a lucky coin event), occurrence of a system event (an event that is independent of a particular player’s game play but involving multiple gaming devices or players (e.g., the game establishment realizing a determined threshold of gaming activity throughout the gaming system, occurrence of a determined time of day or day of week, and the like), and/or occurrence of a random event generated by the random number generator or pseudo random number generator (e.g., output of a predetermined random number entitles all players of a selected rank or class (e.g., gold or silver players) but not players of another rank or class (e.g., silver) to exchange cryptocurrency and loyalty points).

The conversion rules further can stipulate the exchange rate for the exchange. The exchange rate can depend on a number of factors including cryptocurrency value (which varies by type of cryptocurrency), base currency (e.., dollars) recognized by the gaming establishment, type and perceived value of loyalty points relative to the base currency, transaction fees charged to transfer cryptocurrency to the player’s wallet, and period of time over which the exchange rate is fixed.

The conversion rules further can stipulate the protocol details for transferring a corresponding type of cryptocurrency. As will be appreciated, different cryptocurrencies can have differing protocols for transactions involving the respective cryptocurrency. A first cryptocurrency can have a first protocol, or set of actions required for a successful transfer, and a second cryptocurrency can have a second protocol, or set of actions required for a successful transfer. The first and second protocols are typically different from each other. For example, the actions required to transfer Bitcoin are different from the actions required to transfer Ethereum.

The conversion rules further can stipulate limitations on the exchange. The limitations can include or depend on one or more of minimum transaction amount required for the exchange, possible destination accounts (e.g., the resort wallet 118 or cryptocurrency wallet 154) for the converted cryptocurrency, loyalty classification or ranking of players eligible for the conversion, administration of player preferences (e.g., player preferences regarding trigger events for automatic exchanges of cryptocurrency and loyalty points), type of cryptocurrency that may be exchanged for loyalty points, limits on transaction amounts for all cryptocurrencies that may be converted within a specified time period, and limits on transaction amounts for specific types of cryptocurrency that may be converted within a specified period of time), and the like.

The communication instruction set 232, when executed by the processor 204, may enable the gaming device 112 to communicate with the central gaming server 116 and/or a personal gaming device. In some embodiments, the communication instruction set 232 may include instructions that enable the gaming device 112 to pair with a personal gaming mobile device and establish a communication channel with the personal gaming mobile device via the pairing. As an example, the communication instruction set 232 may include instructions that enable NFC, Bluetooth®, Wi-Fi, or other types of communication protocols. It should be appreciated that the communication instruction set 232 may also be updated to reflect when a personal gaming mobile device is paired with the gaming device 112 and such pairing information may include addressing information for the personal gaming device and/or identification information associated with the player 124 of the personal gaming mobile device. Alternatively or additionally, the communication instruction set 232 may enable the gaming device 112 to identify a player 124 of the personal gaming device, identify a loyalty account associated with the player 124 of the personal gaming device, exchange information (e.g., send or receive) with a loyalty application operating on the personal gaming device, or combinations thereof. In some embodiments, the communication instruction set 232 may be configured to operate or drive the network interface 224 to facilitate direct or indirect communications with a personal gaming device.

While shown as separate instruction sets, it should be appreciated that any of the game control instruction set 206, wager credit meter instruction set 210, player interaction instruction set 212, loyalty point award instruction set 218, event monitor instruction set 220, promotional rules 222, crypto conversion rules 226, and crypto conversion instruction set 230 may correspond to a subroutine of the game control instruction set 206 without departing from the scope of the present disclosure.

The gaming device 112 is further shown to include a ticket issuance device 250, a ticket acceptance device 254, a currency in device 258, a currency out device 262, and a card reader 266. The ticket issuance device 250 may be configured to print physical tickets, vouchers, or the like. The ticket acceptance device 254 may be configured to receive, scan, and/or recognize information from an input physical ticket, voucher, or cash. In some embodiments, the ticket issuance device 250 and ticket acceptance device 254 may operate in concert with a common piece of hardware that both accepts and produces physical tickets, vouchers, or the like. Tickets or vouchers printed by ticket issuance device 250 and recognizable by the ticket acceptance device 254 may correspond to physical lottery tickets, casino vouchers, paper coupons, and the like. Alternatively or additionally, the ticket issuance device 250 and/or ticket acceptance device 254 may be connected to ticket or cash reading hardware. In such an embodiment, the ticket issuance device 250 and ticket acceptance device 254 may operate as a driver and/or firmware component for the card reader.

Similarly, the currency in device 258 and currency out device 262 may include or operate in concert with a coin slot or any other type of coin delivery mechanism. The currency in device 258 and currency out device 262 may include hardware, drivers, or firmware that facilitate receiving or distributing tokens, coins, chips, etc. In some embodiments, the currency in device 258 may be configured to determine an amount of coins (an amount of tokens, an amount of chips, etc.), input at the coin slot and convert the values into credits for playing games. The currency out device 262 may correspond to hardware and software configured to output coins, tokens, chips, etc. if a player decides to cash out or convert playing credits back into coins, tokens, or chips, etc.

The card reader 266 may include hardware and/or software configured to read or accept any type of card, or portable credential (e.g., NFC, Bluetooth, Wi-Fi, etc.). In some embodiments, the card reader 266 may include hardware and/or software that enable contactless reading of a card, token, or portable credential. In some embodiments, the card reader 266 may include hardware and/or software that enable contact-based reading of a card, token, or portable credential (e.g., magstripe, chip reader, electrodes, card-receiving slot, etc.). It should be appreciated that the card reader 266 may be configured to receive and reader a card or portable credential, token, in any type of format (e.g., portable plastic card, magstripe card, key fob, etc.). It should also be appreciated that the card reader 266 may be configured to write information or data onto a card or portable credential. Furthermore, in some embodiments, the card reader 266 may be configured to read a player loyalty card in the form of a plastic credit-card shaped credential. In some embodiments, the card reader 266 may enable communications with a loyalty application operating on a player’s personal gaming device.

The gaming device 112 may include one or more display devices 270 configured to render information, live video, communications windows, wagering interface windows, games, interactive elements, and/or other visual output to one or more display screens. The gaming device 112 may include one or more display controllers configured to control an operation of the display device 270. This operation may include the control of input (e.g., player input via the user interface 216, command input via the instruction sets in memory 208, combinations thereof, etc.), output (e.g., display, rendered images, visual game behavior, etc.) and/or other functions of the display device 270.

In an embodiment, the display device 270 comprises one or more display screens that are configured to selectively activate pixels and/or display elements to render one or more games, windows, indicators, interactive elements, icons, characters, lights, images, etc. Non-limiting examples of the display screen may include, but are in no way limited to, a liquid crystal display (LCD), a light-emitting diode (LED) display, an electroluminescent display (ELD), an organic LED (OLED) display, and/or some other two-dimensional and/or three-dimensional display. In some embodiments, the one or more display screens may be separated into a main display and a secondary display.

In an embodiment, the display device 270 comprises one or more projectors to project virtual reality or augmented reality images during the escape room game. The projector(s) can be any projecting device that can project a computer image onto a projection augmented model (PA model) and/or a spatially augmented reality (SAR) model to provide the players 124 with augmented reality, augmented virtuality, and/or virtual reality computer-generated game environments. As will be appreciated, projection mapping, video mapping or SAR typically uses one or more optical devices or projectors that project a beam of light onto a selected escape room space to provide the player with the augmented reality, augmented virtuality, and/or virtual reality computer-generated game environments.

In an embodiment, the display device 270 comprises head-mounted displays worn by the players 124 to view the augmented reality, augmented virtuality, or virtual reality computer-generated game environments.

The display device 270 may include a display driver, a power supply, an input/output, and/or other components configured to enable operation of the display device 270. The display driver may receive commands and/or other data provided by the processor 204 and one or more of the instruction sets in memory 208. In response to receiving the commands, the display driver may be configured to generate the driving signals necessary to render the appropriate images to the display screen. The power supply may provide electric power to the components of the display device 270. In some embodiments, the power supply may include a transformer and/or other electronics that prevent overloading, condition power signals, and/or provide backup power to the display device 270. The input/output may correspond to one or more connections for receiving or exchanging information and/or video from components of the gaming device 112. The input/output may include an interconnection to the network interface 224. By way of non-limiting example, the input/output may include a high-definition multimedia interface (HDMI) input, Ethernet, composite video, component video, H.264, or other video connection.

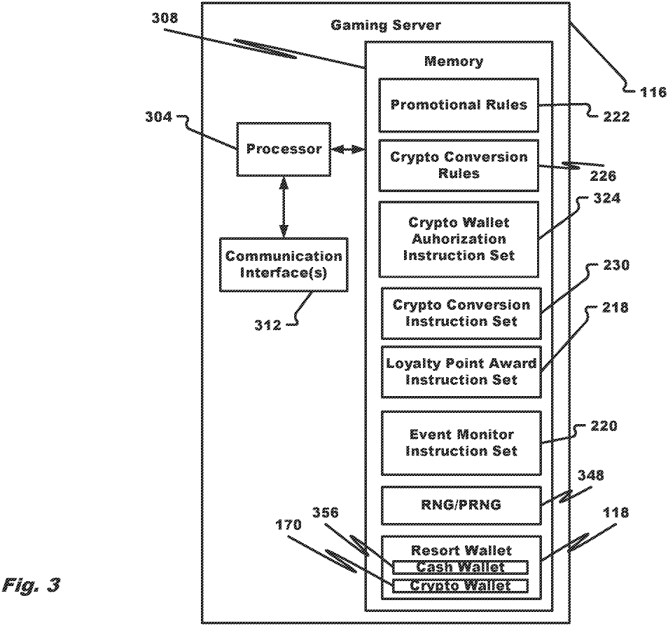

With reference now to FIG. 3, additional details of a gaming server 116 will be described in accordance with embodiments of the present disclosure. The gaming server 116 is shown to include a processor 304, memory 308, and a plurality of communication interfaces 312. These resources may enable functionality of the gaming server 116 as will be described herein. For instance, a communication interface 312 may provide the gaming server 116 with the ability to send and receive communication packets or the like over the gaming network 104. The communication interface 312 can also facilitate communications with the mobile devices 114 via the communication network 108. The communication interface 312 may be provided as a network interface card (NIC), a network port, drivers for the same, and the like. Communications between the components of the gaming server 116 and other devices connected to the gaming network 104 may all flow through the communication interface 312.

The processor 304 may correspond to one or many computer processing devices. The processor 304 may be configured to execute one or more instruction sets stored in memory 308. Upon executing the instruction sets stored in memory 308, the processor 304 enables various authentication functions of the gaming server 116.

The memory 308 may include any type of computer memory device or collection of computer memory devices. The memory 308 may include volatile and/or non-volatile memory devices. Non-limiting examples of memory 308 include Random Access Memory (RAM), Read Only Memory (ROM), flash memory, Electronically-Erasable Programmable ROM (EEPROM), Dynamic RAM (DRAM), etc.

The illustrative instruction sets that may be stored in memory 308 include, without limitation, the promotional rules 222, the cryptocurrency conversion rules 226, the cryptocurrency wallet authorization instruction set 324, the cryptocurrency conversion instruction set 230, the loyalty point award instruction set 218, event monitor instruction set 220, RNG/PRNG 348, and resort wallet 118. Functions of the gaming server 116 enabled by these various instruction sets will be described in further detail herein. It should be appreciated that the instruction sets depicted in FIG. 3 may be combined (partially or completely) with other instruction sets or may be further separated into additional and different instruction sets, depending upon configuration preferences for the gaming server 116. Said another way, the particular instruction sets depicted in FIG. 3 should not be construed as limiting embodiments described herein. Although not depicted, the gaming server 116 may include instructions that enable a processor to store data into the database 184 and retrieve information from the database 184. Alternatively or additionally, the database 184 or data stored therein may be stored internal to the gaming server 116 (e.g., within the memory of the server 116 rather than in a separate database).

In some embodiments, the cryptocurrency wallet authorization instruction set 324, when executed by the processor 304, may enable the gaming server 116 to apply external wallet account authorization requirements to verify that a player is authorized to perform transactions with respect to the wallet and to comply with money laundering rules. To prevent laundering and fraud for these different types of cryptocurrency, the gaming system performs digital account verification by determining, for a selected cryptocurrency, a corresponding set of account verification rules (each cryptocurrency corresponds to a different set of account verification rules), requiring, as part of digital account verification, the selected player to perform an activity set forth in the corresponding set of account verification rules. The conversion rules cause the processor to monitor a communications interface for an indication that a requested activity has been performed. The processor 304 then sets a value of a performance activity indicator to indicate whether the activity was performed successfully or unsuccessfully. A first value of the activity performance indicator indicates that the selected player performed the activity successfully (or has a first value) and that the selected player is authorized to use the digital account and thereafter can perform the requested conversion from or to cryptocurrency or transfer of cryptocurrency from the casino or resort wallet 170 to the player’s cryptocurrency wallet 154. A second value of the activity performance indicator indicates that the selected player failed to perform the activity successfully and that the selected player is not authorized to use the digital account and thereafter is unable to perform the requested conversion or transfer.

For example, to verify that a destination wallet is owned by the selected player for cryptocurrencies such as Bitcoin that is designed for maintaining a decentralized payment network, the selected player could be required to submit a blank or transfer of zero cryptocurrency funds, or some trivial amount of cryptocurrency funds, between his or her destination account associated with the player’s wallet 154 and an account associated with the casino’s cryptocurrency wallet 170 within a certain timeframe. For example, the gaming system 100 can prompt the player to transmit a blank transaction request, a transaction request for zero funds, or a transaction request for a trivial amount of funds between the player’s gaming establishment fund management account 170 and the player’s external cryptocurrency account 154 within a designated period to verify that the player owns the external cryptocurrency account. In certain such embodiments, the gaming system (or a component of the gaming establishment fund management system) determines, such as randomly determines, the trivial amount of funds to include in the transaction request. When the action is performed successfully (e.g., the posted transaction has been properly verified (consensus) by the quorum of miners or validators on the associated digital ledger 158 (e.g., blockchain), the performance indicator is set to the first value, and the processor would then allow the player to transfer converted cryptocurrency funds to the identified destination account. When the action is not performed successfully within a specified time period, the indicator is set to the second value.

For other cryptocurrencies, such as Ethereum that is designed for maintaining a decentralized payment network and storing computer code which can be used to power tamper-proof decentralized financial contracts and applications, the selected player can verify that he or she owns or is otherwise authorized to use the destination account by taking a string of random data or a random message or other information (i.e., a timestamp, nonce) generated by the gaming system (such as by a random number generator or pseudorandom number generator 348) and sign that data with the private key tied to the desired destination account associated with the player’s wallet 154. The signed data can be posted on the digital ledger 158 to the account associated with the player’s wallet and when properly signed as shown by the public key of the player’s wallet causes the indicator to have the first value. Alternatively, the signed data can be returned to the gaming system 100. Responsive to the gaming system 100 verifying that the provided data (such as by comparing the signature of the provided data against a public key associated with the player’s external cryptocurrency account that triggered the transfer), the gaming system 100 completes the transfer (i.e., transfers the cryptocurrency funds to the player’s wallet 154. However, if the gaming system 100 is unable to verify the provided data (e.g., if the signature of the provided data does not match the public key associated with the player’s wallet 154), then the transfer is not made to the player’s wallet 154 and the cryptocurrency is transferred to maintained as the player’s share of the cryptocurrency wallet 170.

For other cryptocurrencies, such as Cardano, a simplified smart contract provided by the gaming system is digitally sent to the player’s cryptocurrency wallet 154 and, when successfully signed and posted by the player on the digital ledger 158 to the player’s wallet, establishes the player’s authorization to use the account and causes the indicator to have the first value.

In other cryptocurrencies, homomorphic encryption can be employed that permits the player’s wallet to perform selected computations on encrypted data provided by the casino’s wallet or the cryptocurrency conversion function without first decrypting it. Matching results posted on the digital ledger 158 confirm the player’s authorization to use the wallet 154 and causes the indicator to have the first value.

The random number generator or pseudorandom number generator (RNG/PRNG) 348 is used to generate a random event as noted above. The RNG/PRNG 348 generates a distribution of numbers or game symbols (the random number value) that are not reasonably predictable by a random chance. Random number generators can be truly random hardware random generators (HRNGS), which generate random numbers as a function of current value of some physical environment attribute that is constantly changing in a manner that is practically impossible to model, or pseudo-random number generators (PRNGs), which generate numbers that look random, but are actually deterministic, and can be reproduced if the state of the PRNG were known. In some applications, the RNG/PRNG 348 uses computational algorithms that can produce long sequences of apparently random results, which are in fact determined by a shorter initial value, known as a seed value or key.

In one embodiment, the RNG/PRNG 348 is a PRNG, which constantly generates a sequence of simulated random numbers, at a rate of hundreds or perhaps thousands per second. As soon as a “play” button is pressed or other game initiation is received from the player or a predetermined event occurs, the most recent random number is used to determine the result. This means that the result varies depending on exactly when the game is played. In other embodiments, the RNG/PRNG 348 is a cryptographic random number generator.

In some embodiments, the resort wallet 118 comprises a cash wallet set of data structures 356 that tracks a cash balance and a cryptocurrency wallet set of data structures 170 that tracks cryptocurrency balances not only collectively for the gaming system 100 but also individually for each player’s account managed by the gaming system 100. When cash or cryptocurrency is moved from a central resort wallet to a player’s wallet, the appropriate data structures in each set of data structures are updated to reflect the transfer.

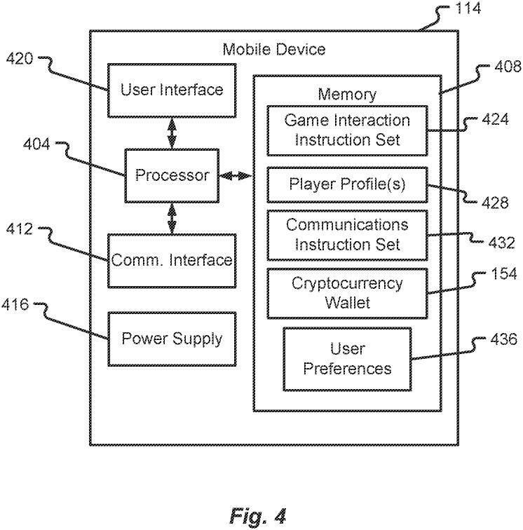

With reference now to FIG. 4, additional details of the components that may be included in a mobile device 114 will be described in accordance with at least some embodiments of the present disclosure. The mobile device 114 is shown to include a processor 404, memory 408, a communication interface 412, and a user interface 420. In some embodiments, the processor 404 may be similar or identical to any of the other processors 204, 304 depicted and described herein and may correspond to one or many microprocessors, CPUs, microcontrollers, Integrated Circuit (IC) chips, or the like. The processor 404 may be configured to execute one or more instruction sets stored in memory 408. In some embodiments, the instruction sets stored in memory 408, when executed by the processor 404, may enable the mobile device 114 to provide game play functionality, interact with gaming machines 112, pair with gaming machines 112, or any other type of desired functionality.

The communication interface 412 may be similar or identical to the network interface 224 and/or communication interfaces 312 depicted and described herein. The nature of the communication interface 412 may depend upon the type of communication network 108 for which the mobile device 114 is configured. Examples of a suitable communication interfaces 412 include, without limitation, a WiFi antenna and driver circuit, a Bluetooth antenna and driver circuit, a cellular communication antenna and driver circuit, a modulator/demodulator, etc. The communication interface 412 may include one or multiple different network interfaces depending upon whether the mobile device 114 is connecting to a single communication network 108 or multiple different types of communication networks. For instance, the mobile device 114 may be provided with both a wired communication interface 412 and a wireless communication interface 412 without departing from the scope of the present disclosure.

The user interface 420 may include a combination of a user input and user output device. For instance, the user interface 420 may include a display device, a microphone, a speaker, a haptic feedback device, a light, a touch-sensitive display, a button, or a combination thereof. The user interface 420 may also include one or more drivers for the various hardware components that enable user interaction with the mobile device 114.

The memory 408 may be similar or identical to other memory 208, 308 depicted and described herein and may include one or multiple computer memory devices that are volatile or non-volatile. The memory 408 may be configured to store instruction sets that enable player interaction with the mobile device 114 and that enable game play at the mobile device 114. Examples of instruction sets that may be stored in the memory 408 include a game interaction instruction set 424, player profile(s) 428, cryptocurrency wallet 154, user preferences 436, and a communication instruction set 432. In addition to the instruction sets, the memory 408 may also be configured to store data that is useable by the various instruction sets. Examples of such data that may be stored in memory 408 include, without limitation, wallet public and private key pair.

In some embodiments, the game interaction instruction set 424, when executed by the processor 404, may enable the mobile device 114 to facilitate one or more games of chance or skill and produce interactions between the player and the game of chance or skill. In some embodiments, the game interaction instruction set 424 may include subroutines that present one or more graphics to the player 124 via the user interface 420, subroutines that calculate whether a particular wager has resulted in a win or loss during the game of chance or skill, subroutines for determining payouts for the player in the event of a win, subroutines for exchanging communications with another device, such as the gaming server 116 and/or gaming machine 112, subroutines for determining lottery bonus gameplay opportunities during game play, and any other subroutine useful in connection with facilitating game play at the mobile device 114 and/or gaming machine 112.

The player profile(s) 428 include a variety of player-specific data structures including player identification and login credentials.

The cryptocurrency wallet 154 comprises data structures related to the player’s cryptocurrency wallet, including private and public keypair and seed used to generate the keys.

The communication instruction set 432, when executed by the processor 404, may enable the mobile device 114 to communicate via the communication network 108. In some embodiments, the communication instruction set 432 may be similar or identical to the communication instruction set 232 and may be particular to the type of communication network 108 used by the mobile device 114. As an example, the communication instruction set 432 may be configured to enable cellular, WiFi, and/or Bluetooth communications with other devices. The communication instruction set 432 may follow predefined communication protocols and, in some embodiments, may enable the mobile device 114 to remain paired with a gaming machine 112 as long as the mobile device 114 is within a predetermined proximity (e.g., 20-30 feet, an NFC communication range, or a Bluetooth communication range) and paired with the gaming machine 112. In some embodiments, the communication instruction set 432 enables a mobile device application of the mobile device to negotiate a secure, authenticated connection with the proper functionality, versions and security settings.

The user preferences 436 may correspond to gaming or wager preferences that are desired by the player 124 of the mobile device 114. In some embodiments, the user preferences 436 may comprise cryptocurrency type-dependent events that may automatically trigger a request to exchange cryptocurrency and loyalty points. In some embodiments, the user preferences 436 may include cryptocurrency and loyalty point exchange preferences that are referenced by the cryptocurrency conversion instruction set 230 and that may enable automated conversions to occur upon occurrence of predetermined events. By way of example, the player could configure the conversion to happen after the end of his or her play session. In another example, the player could configure the conversion to happen nightly, or at the end of his or her casino trip, once his or her accumulated loyalty point balance hits some minimum threshold, or any other appropriate conversion triggering event. For example, the player may elect to automatically convert his or her earned player loyalty points after the end of a play session at an EGM. Automated conversion might be tied to player loyalty status or play levels. The gaming device 112 and mobile device 128 may be configured to communication with one another and, in some embodiments, the mobile device 114 may provide some or all of the user preferences 436 to the gaming device 112 for use during a game play session or at least until the user 124 leaves the gaming device 112 (e.g., as determined by the mobile device 114 leaving the predetermined proximity of the gaming device 112).

The mobile device 114 is also shown to include a power supply 416. The power supply 416 may correspond to an internal power supply that provides AC and/or DC power to components of the mobile device 114. In some embodiments, the power supply 416 may correspond to one or multiple batteries. Alternatively or additionally, the power supply 416 may include a power adapter that converts AC power into DC power for direct application to components of the mobile device 114, for charging a battery, for charging a capacitor, or a combination thereof.

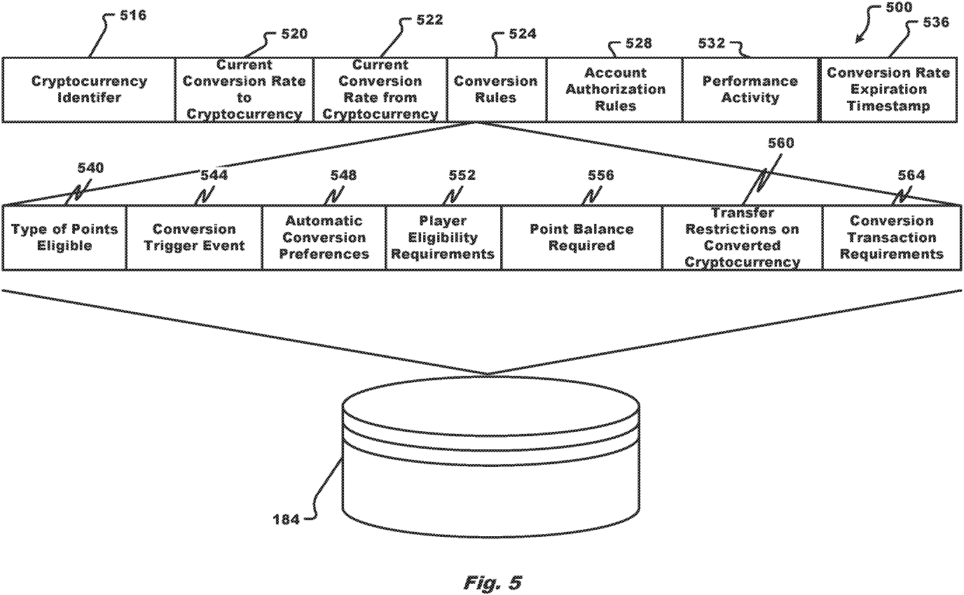

With reference now to FIG. 5, additional details of data that may be stored in the database 184 will be described in accordance with at least some embodiments of the present disclosure. The database 184 may be configured to store one or multiple data structures 500 that are used in connection with the various types of cryptocurrencies recognized by the gaming system 100. In some embodiments, the data stored in the data structures 500 may be stored for a plurality of different cryptocurrencies or for a single player cryptocurrency. The data structures 500 may include a plurality of data fields that include, for instance, a cryptocurrency identifier field 516, a current conversion rate to cryptocurrency field 520, current conversion rate from cryptocurrency field 522, conversion rules field 524, an account authorization rules field 528, a performance activity field 532, and a conversion rate expiration timestamp field 536.

The cryptocurrency identifier field 516 may be used to store any type of information that identifies a cryptocurrency. In some embodiments, the cryptocurrency identifier field 516 stores one or more of cryptocurrency name information for the corresponding cryptocurrency and a corresponding unique identifier for the cryptocurrency relative to cryptocurrency identifier field values for other cryptocurrencies.

The current conversion rate to cryptocurrency field 520 may be used to store current rates or ratios to be used to convert to the corresponding cryptocurrency identified in field 516 from loyalty points and current conversion rate from cryptocurrency field 522 may be used to store current rates or ratios to be used to convert from the corresponding cryptocurrency to loyalty points. As will be appreciated, these rates are not necessarily inversely related to each other but can be values that reflect the desirability or undesirability of either transaction. Additionally, a first cryptocurrency can have a value for field 520 or 522 that is different than a value for a second cryptocurrency for field 520 or 522, respectively.

The conversion rules field 524 can store conversion rules to be used to exchange cryptocurrency and loyalty points and transfer cryptocurrency to a wallet associated with the gaming system 100 or player 124. Examples of data stored in the field 524 include type of loyalty points eligible for exchange 540, conversion trigger event 544, automatic conversion preferences 548, player eligibility requirements 552, minimum point balance required 556, transfer restrictions on converted cryptocurrency 560, and conversion transaction (protocol) requirements 564.

A value of the type of points eligible 540 indicates which type and/or how many loyalty points of each type of loyalty points can be exchanged with the identified cryptocurrency. In some applications, there is only one type of loyalty points. In some applications in which multiple types of loyalty points are awarded to players, each type of loyalty point can be exchangeable with different types of cryptocurrency.

A value of conversion trigger event 544 indicates what trigger events are required for the corresponding cryptocurrency to be exchangeable with loyalty points. Exemplary trigger events comprise, for example, one or more of an amount of game play by the selected player over a selected time interval equaling a determined level, an amount of money spent by the selected player over the selected time interval equaling a determined amount, occurrence of a determined game event, occurrence of a determined system event, and occurrence of a determined random event. Different cryptocurrency types can have different sets of conversion trigger events.

A value of the automatic conversion preferences 548 indicates what user preferences are permitted for the corresponding identified cryptocurrency to be exchanged automatically. As will be appreciated, a first cryptocurrency can have a first set of permissible automatic exchange user preferences and a second cryptocurrency can have a different second set of permissible automatic exchange user preferences.

A value of the player eligibility requirements 552 indicates, for the corresponding cryptocurrency, the eligibility requirements for a user to exchange loyalty points for the corresponding identified cryptocurrency. Eligibility requirements include, for example, player classification or rank (e.g., gold, silver or bronze). Different cryptocurrency types can have different sets of player eligibility requirements.

A value of point balance required field 556 indicates, for the corresponding cryptocurrency, a minimum or maximum loyalty point balance or cryptocurrency balance for an exchange to be permitted. As will be appreciated, different cryptocurrencies can have differing minimum and/or maximum point balance requirements.

A value of the transfer restrictions on converted cryptocurrency 560 indicates, for the corresponding cryptocurrency, transfer restrictions upon transferring the converted cryptocurrency to an external cryptocurrency wallet 154 of the player. Examples of such restrictions include a minimum or maximum transaction size, a required player classification or rank, and the like. Different cryptocurrency types can have different sets of transfer restrictions.

A value of conversion transaction requirements 564 indicates, for the corresponding cryptocurrency, the protocol to be used in transferring the converted cryptocurrency to the player’s wallet 154. Different cryptocurrency types can have different conversion transaction requirements.

The account authorization rules field 528 can store, for the corresponding cryptocurrency, account authorization rules required for transfer to the player’s wallet 154 to occur. As discussed above, different cryptocurrencies have differing account authorization rules.

The performance activity field 532 can store, for the corresponding cryptocurrency, the action to be successfully completed for the performance indicator to have a value permitting cryptocurrency transfer to the requesting player’s wallet 154. Different cryptocurrencies can have differing actions to be completed successfully. As indicated, Bitcoin, for example, can require a cryptocurrency transfer from the player’s wallet to the resort wallet to be recorded on the digital ledger for successful account verification. Ethereum, by contrast, can require a string of characters provided by the gaming system 100 to be signed with the player’s private key and recorded on the digital ledger for successful account verification.

The conversion rate expiration timestamp field 564 can store, for the corresponding cryptocurrency, the timestamp upon expiration of which the rate in one or both of fields 520 and 522 is no longer valid for cryptocurrency and loyalty point exchanges.

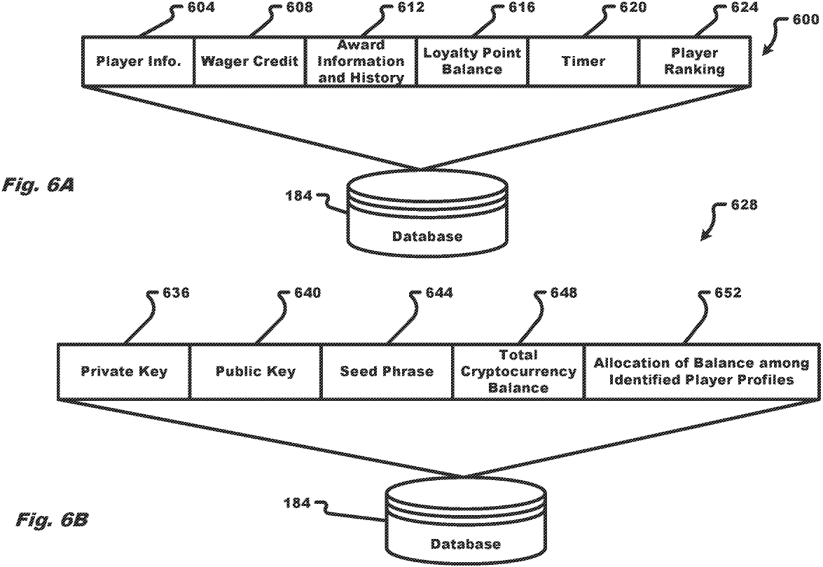

With reference now to FIG. 6A, additional details of data that may be stored in the database 184 will be described in accordance with at least some embodiments of the present disclosure. The database 184 may be configured to store one or multiple data structures 600 that are used in connection with gaming activities of a player. In some embodiments, the data stored in the data structures 600 may be stored for a plurality of different player profiles or for a single player profile. The data structure 600 may include a plurality of data fields that include, for instance, a player information field 532, a wager credit field 608, award information and history field 612, loyalty points balance field 616, a timer field 620, and a player ranking field 624.

The player information field 604 may be used to store any type of information that identifies a player. In some embodiments, the player information field 604 may store one or more of username information for a player 124, contact information for the player (such as email address, phone number, social website webpage universal resource locator, and the like), password information for a player account, player status information, accommodations associated with the player 124, and any other type of customer service management data that may be stored with respect to a player 124.

The wager credit field 608 may be used to store data about a player’s 124 available credit with the casino or a plurality of casinos. For instance, the wager credit field 608 may store an electronic record of available credit in the player’s account and whether any restrictions are associated with such credit. The wager credit field 608 may further store information describing a player’s available credit over time, wagers made over time, cash out events for the player, winning events for the player, and the like.

The award information and history field 612 may be used to store information describing awards that have been paid to the player 124 or that are available to be paid in response to particular events occurring within the gaming system 100. As a non-limiting example, the award information and history field 612 may be used to store electronic records for values of awards that are available to or have been paid to the player 124.

The field 612 may also store data related to awards, bonuses, mini bonuses, jackpots, side bets, etc. granted to the player 124. The field 612 may also indicate when such awards were granted to the player 124, whether the awards have been redeemed, whether the awards are being funded by a game of chance or skill, a mini bonus associated with an event, or a side bet award associated with the occurrence or nonoccurrence of an event.

The loyalty points balance field 620 may be used to store current loyalty point balances by type of loyalty points for the corresponding player 124. The field 620 is incremented and decremented as loyalty points are added to and removed from the player’s loyalty account.

The timer field 620 may be used to store a timer value associated with tracking whether or not a particular player 124 or the gaming system 100 has completed a particular event or a plurality of events within a predetermined amount of time. By way of example, the timer field value may be used to determine whether the player 124 has completed an account verification activity timely. The value of the timer within the timer field 620 may count up, count down, or increment in any known way to track a passage of time. Alternatively or additionally, time may be measured by an occurrence of events within the gaming system 100 rather than being measured absolutely.

The player ranking field 624 may be used to store a player ranking associated with the corresponding player 124. Player ranking may be measured in various ways. In one embodiment, the player ranking is based on membership in a platinum, gold, silver, or bronze class, with platinum being the highest value to the casino and bronze the lowest. In one embodiment, the player ranking is based on a proficiency level or performance rank in one or more gaming sessions. Other player loyalty classification schemes are possible depending on the application.

With reference now to FIG. 6B, additional details of data that may be stored in the database 184 will be described in accordance with at least some embodiments of the present disclosure. The database 184 may be configured to store one or multiple data structures 628 that are used in connection with the gaming establishment’s resort wallet 118. The data structure 628 may include a plurality of data fields that include, for instance, a private key field 636, public key field 640, seed phrase field 644, total cryptocurrency balance field 648, and allocation of balance among identified player profiles field 652. As will be appreciated, each type of cryptocurrency offered to players 124 by the gaming establishment will have a corresponding set of data structure 628 containing different field values.

The private and public key fields 636 and 640 can store the private and public key pair associated with the corresponding cryptocurrency account of the gaming establishment.

The seed phrase field 644 can store the seed phrase used to generate the private key. As will be appreciated, each of the private and seed phrase fields can be encrypted for added security.

The total cryptocurrency balance field 648 can store the current balance of the corresponding cryptocurrency in the gaming establishment’s account.

The allocation of balance among identified player profiles field 652 can store variables indicating, for each identified player profile data structure 600, a corresponding fractional share of the total cryptocurrency balance in the field 648. The variables can include a link to the data structure 600 for the corresponding player 124. The field 652 is incremented and decremented in response to player’s gaming and other activities at the gaming establishment.

In certain embodiments, access to the player’s gaming establishment cryptocurrency account public key is restricted using gaming establishment credentials associated with the player (i.e., username/password information, a player tracking card and PIN, etc.). Once the player authenticates themselves using his or her gaming establishment credentials, the gaming system 100 enables the player to view his or her gaming establishment cryptocurrency account public key and use that public key as the destination account identifier to include in a cryptocurrency transaction request.

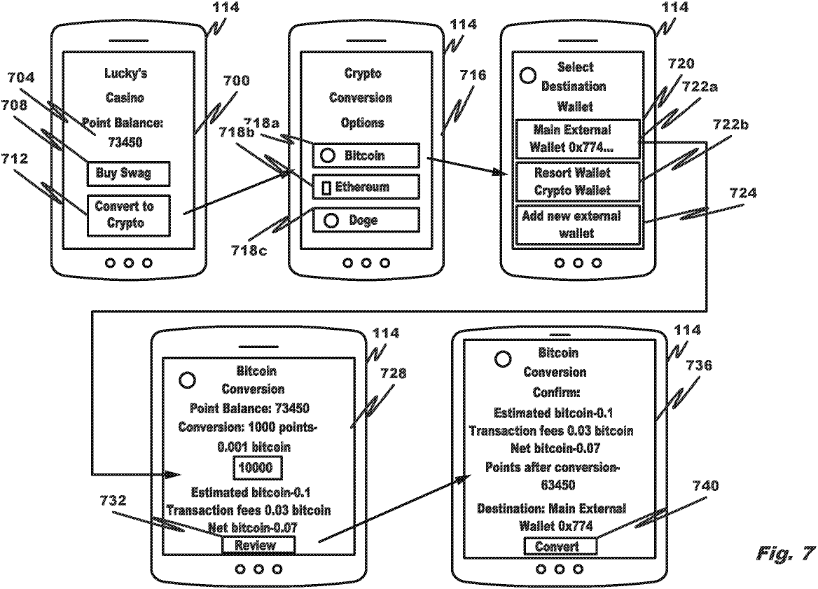

For example, FIG. 7 illustrates a sequence of messages displayed via a mobile device application of the mobile device 114. In this example, the mobile device application is associated with the gaming establishment (e.g., Lucky’s Casino). As seen in FIG. 7, after the player authenticates themselves via his or her gaming establishment credentials, the mobile device application displays a first message 700 to the player 124 providing a loyalty point balance 704 and a first option 708 for the player to use part or all of the balance to buy swag and a second option 712 for the player to convert part or all of the balance to cryptocurrency for transfer to a gaming establishment or player wallet. Responsive to the player selecting the player-selectable option to convert to cryptocurrency option 712, the mobile device application displays a second message 716 to the player identifying different cryptocurrency types that may be exchanged for the loyalty points (e.g., Bitcoin 718a, Ethereum 718b, and Doge 718c). Responsive to the player selecting Bitcoin 718a, the mobile device application displays a third message 720 to the player identifying the destination locations, namely the external player wallet (e.g., main external wallet 0x774 ...) 722a or the gaming establishment wallet of the player (e.g., resort wallet cryptocurrency wallet) 722b or providing the player with the option to add a new external wallet 724. As seen in the third message 720, the public key is displayed by the mobile device 114 as a machine-readable code (i.e., a QR code) and as an alphanumeric string. However, it should be appreciated that other embodiments employ additional or alternative techniques for presenting the player’s gaming establishment cryptocurrency account public key, such as a linear barcode, a matrix barcode, hyperlink, and the like. Responsive to the player selecting the external player wallet 722a, the mobile device/application displays a fourth message 728 providing the player with the loyalty point balance that may be converted to Bitcoin (e.g., 73450 points), the conversion rate (1,000 points equals 0.001 Bitcoin), the number of loyalty points to be converted (e.g., 10,000 or estimated 0.1 Bitcoins), the estimated bitcoin transaction fees for the transaction (0.03), the net Bitcoins to the player from the exchange (0.07 Bitcoins), and a selectable option 732 to review the proposed transaction). Responsive to the player selecting the review option 732, the mobile device application displays a fifth message 736 asking the player to confirm the Bitcoin conversion (e.g., estimated Bitcoin from the exchange 0.1 Bitcoins, less transaction fees of 0.03 Bitcoins, to yield a net Bitcoin realized of 0.07 Bitcoins, leaving loyalty points after conversion of 63,450, with the 0.07 Bitcoins to be transferred to the player’s external wallet or main External wallet 0x774 . . ) and a selectable confirm option 740 to proceed with the transaction. Responsive to the player selecting the confirm option, the transaction is executed and the Bitcoins realized from the exchange transferred to the player’s external wallet.

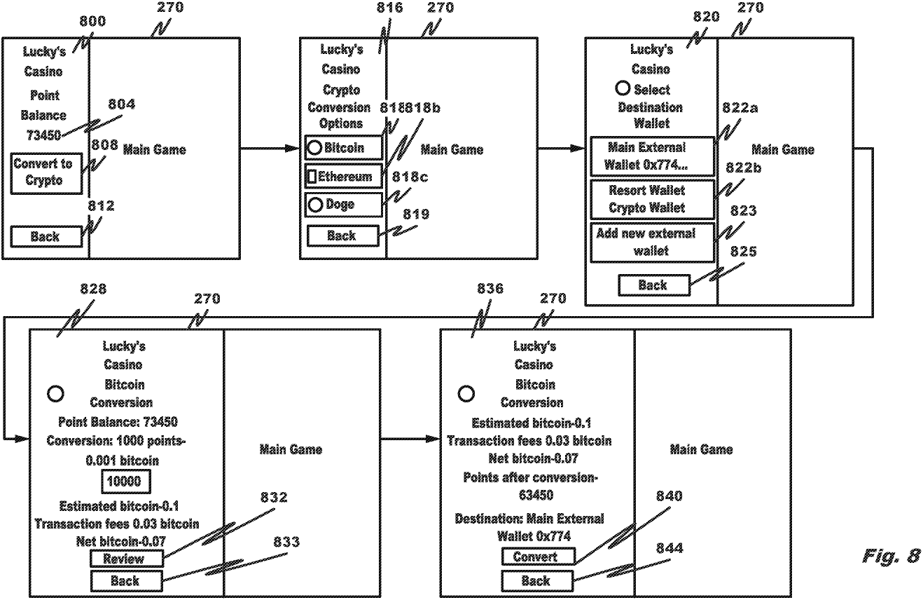

FIG. 8 illustrates another sequence of messages displayed via the display device(s) 270 of the gaming device 112. In this example, the messages are displayed in a sub-portion of the display with the main game (e.g., a game of chance, skill or a combination thereof) being displayed in another sub-portion of the display. In this example, the mobile device application is associated with the gaming establishment (e.g., Lucky’s Casino). As seen in FIG. 8, after the player authenticates themselves via his or her gaming establishment credentials, the gaming device 112 displays a first message 800 to the player 124 providing a loyalty point balance 804 and a convert option 808 for the player to convert part or all of the balance to cryptocurrency for transfer to a gaming establishment or player wallet and a back option to return to a prior display configuration 812. Responsive to the player selecting the player-selectable convert option 812 to convert to cryptocurrency, the gaming device 112 displays a second message 816 to the player identifying different cryptocurrency types that may be exchanged for the loyalty points (e.g., Bitcoin 818a, Ethereum 818b, and Doge 818c) and a back option 819 to return to a prior display configuration. Responsive to the player selecting Bitcoin 818a, the gaming device 112 displays a third message 820 to the player identifying the destination locations, namely the external player wallet (e.g., main external wallet 0x774 ...) 822a or the gaming establishment wallet of the player (e.g., resort wallet cryptocurrency wallet) 822b or providing the player with the option 823 to add a new external wallet or a back option 825 to return to a prior display configuration. Responsive to the player selecting the external player wallet 822a, the gaming device 112 displays a fourth message 828 providing the player with the loyalty point balance that may be converted to Bitcoin (e.g., 73450 points), the conversion rate (1,000 points equals 0.001 Bitcoin), the number of loyalty points to be converted (e.g., 10,000 or estimated 0.1 Bitcoins), the estimated bitcoin transaction fees for the transaction (0.03), the net Bitcoins to the player from the exchange (0.07 Bitcoins), a selectable review option 832 to review the proposed transaction) and a back option 833 to return to a prior display configuration. Responsive to the player selecting the review option 832, the mobile device displays a fifth message 836 asking the player to confirm the Bitcoin conversion (e.g., estimated Bitcoin from the exchange 0.1 Bitcoins, less transaction fees of 0.03 Bitcoins, to yield a net Bitcoin realized of 0.07 Bitcoins, leaving loyalty points after conversion of 63,450, with the 0.07 Bitcoins to be transferred to the player’s external wallet or main external wallet 0x774 . . ) and a selectable convert option 840 to proceed with the transaction and a back option 844 to return to a prior display configuration. Responsive to the player selecting the convert option 840, the transaction is executed and the Bitcoins realized from the exchange transferred to the player’s external wallet. While FIG. 8 is discussed with reference to a gaming device, it is to be understood that the various options could be performed by a kiosk, or other type of gaming device.

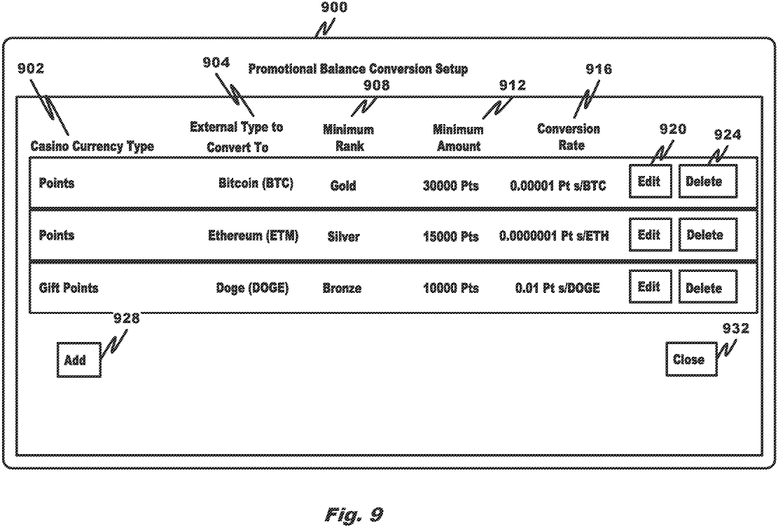

FIG. 9 provides an example of a configuration user interface display 900 that could be coupled with the gaming system 100 and used to set promotional balance to cryptocurrency conversion ratios and configure conversion rules. The display 900 comprises a table listing casino currency type 902 (e.g., first and second different types of loyalty points and gift points), external type of cryptocurrency to convert to 904 (e.g., Bitcoin (BTC), Ethereum (ETM), and Doge (Bronze), minimum player rank or classification required for the exchange 908 (e.g., gold for Bitcoin, silver for Ethereum, and bronze for Doge), minimum point balance required for transfer 912 (e.g., 30,000 loyalty points for Bitcoin, 15,000 loyalty points for Ethereum, and 10,000 gift points for Doge), conversion rate 916 (e.g., 0.00001 loyalty points/1 Bitcoin, 0.0000001 loyalty points/1 Ethereum, and 0.01 gift points/1 Doge), and, for each row in the table, an edit option 920 to edit the preceding entries in the corresponding row or delete option 924 to delete the corresponding row. Further options include to add 928 further rows to the table and close (and save) 932 the edited table. As can be seen from FIG. 9, the casino may condition the ability to convert loyalty points to cryptocurrency upon the player performing some minimum transaction size. This minimum threshold may help ensure the value accrued to the player is high enough to cover the underlying transaction fees. This limit may be static or based upon the current transaction fees associated with one or more digital ledger.

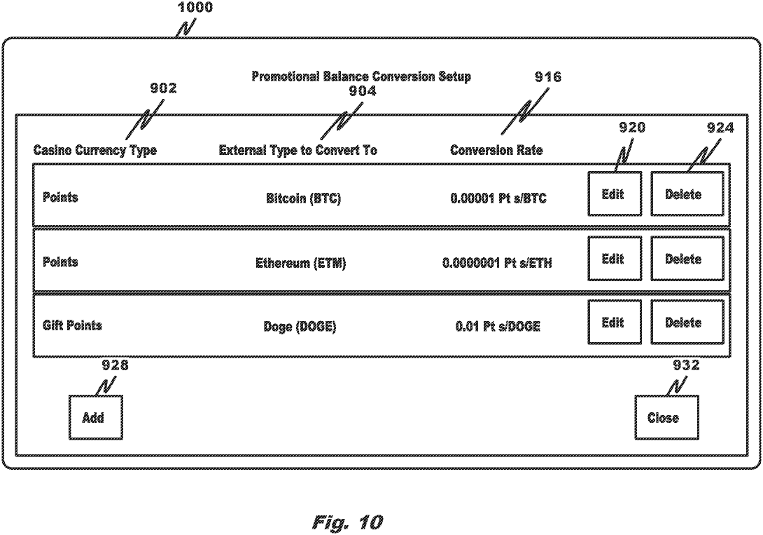

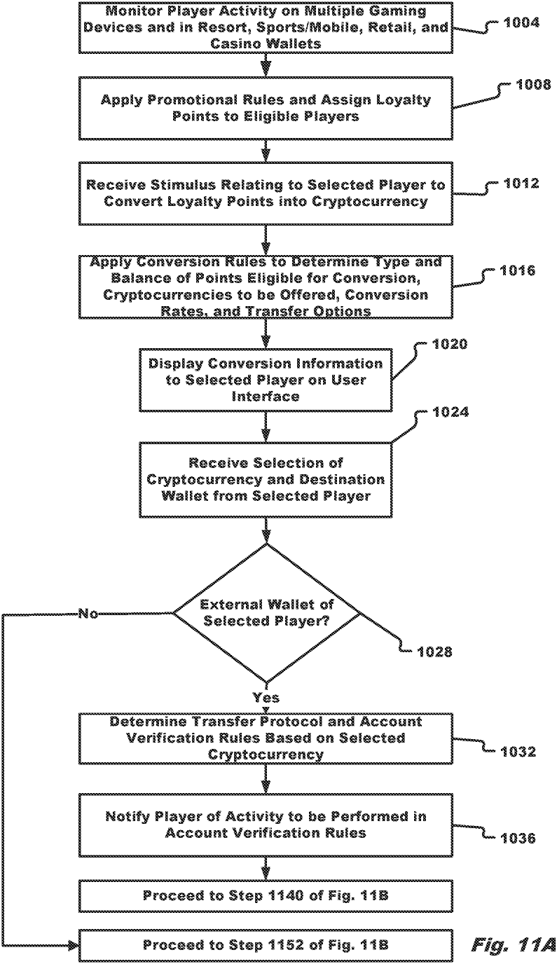

FIG. 10 provides an example of a configuration user interface display 1000 that could be coupled with the gaming system 100 and used to set promotional balance to cryptocurrency conversion ratios. The display 1000 comprises a table listing casino currency type 902, external type of cryptocurrency to convert to 904, conversion rate 916 (e.g., 0.00001 loyalty points/1 Bitcoin, 0.0000001 loyalty points/1 Ethereum, and 0.01 gift points/1 Doge), and, for each row in the table, an edit option 920 to edit the preceding entries in the corresponding row or delete option 924 to delete the corresponding row. Further options include to add 928 further rows to the table and close (and save) 932 the edited table.

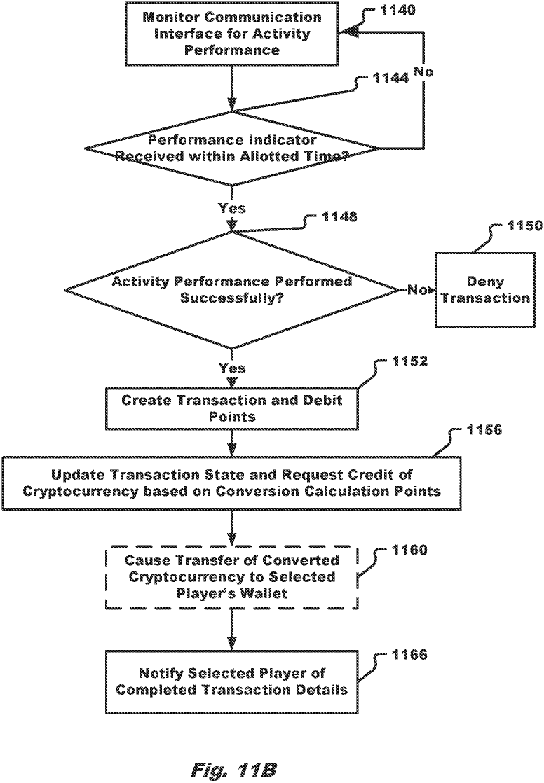

With reference now to FIGS. 11A and 11B, a method of exchanging cryptocurrency and loyalty points will be described in accordance with embodiments of the present disclosure.

The method begins in step 1004 with the gaming server 116 monitoring player activities on multiple gaming devices 112 and in the resort, sports/mobile, retail, and casino wallets 118, 126, 122, and 120, respectively, to detect predetermined loyalty point award activities. The activities may or may not require the player 124 to input his or her loyalty point account information, such as by swiping a player loyalty card.

The method may continue in step 1008 by the gaming server 116 applying promotional rules to the detected award activities and assigning loyalty points to one or more eligible players. Eligibility can be based on a number of criteria, including a player classification or ranking, player account status, and the like. The gaming server 116 increments the loyalty point field 616 to provide an updated loyalty point balance.

The method can continue in step 1012 by the gaming server 116 receiving a stimulus relating to offering a selected player an option to convert loyalty points into cryptocurrency. The stimulus can take many forms, including receipt of a player request, occurrence of a trigger event (such as detection of a minimum loyalty point balance in the player’s account or occurrence of a game event, system event, or random event, detection of a minimum amount of play by the player within a predetermined amount of time, detection of an amount of money spent at the gaming establishment within a predetermined amount of time, and the like).

The method can continue in step 1016 by the gaming server 116 applying conversion rules to determine a type and balance of points eligible for conversion, cryptocurrencies to be offered, conversion rates, and transfer options and in step 1020 displaying the conversion information to the selected player on a user interface, as shown in FIGS. 9 and 10.

The method can continue in step 1024 by the gaming server 116 receiving selection of the cryptocurrency and destination wallet from the selected player, as discussed with reference to FIGS. 9 and 10.

The method can continue in query 1028 by the gaming server 116 determining whether or not the player has selected an internal or external wallet as the destination account for the cryptocurrency. When the player elects to transfer the cryptocurrency to an account in the resort wallet 118, the gaming server proceeds to step 1152 of FIG. 11B (discussed below). When the player elects to transfer the cryptocurrency to an external wallet 154 of the player, the gaming server 116 proceeds to step 1032.

In either option, the player 124 using his or her mobile device 114 may be required to establish a pairing or linkage between the mobile device 114 and the gaming system 100. The pairing or linkage between the mobile device and the gaming system (e.g., EGM or kiosk) occurs via one or more applications being run or executed on the mobile device. In certain embodiments, the mobile device application utilized to effect cryptocurrency transfer to and from the gaming system 100 is a location based digital wallet enabled application, such as a Passbook-enabled or Wallet-enabled application, which is accessible when the player enters a gaming establishment. In certain embodiments, the mobile device application utilized to effect cryptocurrency transfer to and from the gaming system is downloaded to the mobile device from an application store. In certain embodiments, the mobile device application utilized to transfer cryptocurrency to and from the gaming system is downloaded to the mobile device from one or more websites affiliated with the gaming establishment (which are accessible directly by the player and/or by a link opened when the player scans a QR code associated with the EGM).

In certain embodiments, after a player has opened an application on a mobile device and selected an action to be performed, the gaming system determines if the mobile device application is associated with an active authorization token previously created by the system. In these embodiments, an authorization token is a time-based token that expires after a designated period of time and that is associated with an additional level of player authentication beyond a player’s application username and application password.

If the gaming system determines that the application is not associated with an active authorization token previously created by the system, the mobile device application prompts the player to provide identifying information, such as a personal identification number or biometric identifier. The mobile device application stores the provided identifying information as mobile device encrypted data. Following the player providing identifying information, the mobile device application prompts the player to cause the mobile device to engage a gaming device (or a component of the gaming device), such as prompting the player to tap the mobile device to a designated portion of the gaming device. It should be appreciated that any reference herein to a player tapping the mobile device to a designated portion of the gaming device (or a component of the gaming device) may or may not include the player pressing a fingerprint scanner (if the mobile device is equipped with such a fingerprint scanner) while concurrently engaging the gaming device (or a component of the gaming device). In other embodiments, the mobile device application verifies the identifying information of the player by communicating with a verification/authentication server over one or more wireless communication protocols, such as Wi-Fi protocol, a cellular communication protocol (e.g., 3G or LTE), to obtain the active authorization token.

In certain embodiments, following the player causing the mobile device to engage the gaming device (e.g., the player taps the mobile device to a player tracking card reader or other designated location(s) of the gaming device), the mobile device application communicates, via a wireless communication protocol, the provided identifying information and the requested action to be performed to the gaming device (or to a component associated with the gaming device). For example, upon the player tapping the mobile device to a player tracking card reader or other designated location(s) of the gaming device (or otherwise moving the mobile device to within a designated distance of the player tracking card read or other designated locations(s) of the gaming device), the mobile device application sends the identifying information and the requested action to a component of a gaming establishment management system located inside the gaming device (i.e., a component of the gaming device), such as a NexGen™. player tracking component of an Advantage™ system. NexGen™. and Advantage™.

If the gaming system determines that the identifying information is invalid, the system communicates an invalid identifying information response to the mobile device. For example, an identifying information status message is communicated to the mobile device which reports whether the identifying information is valid or invalid. The mobile device application then displays one or more messages regarding the invalid identifying information and prompts the player to provide identifying information, such as a personal identification number or biometric identifier. In certain such embodiments, if the mobile device receives a communication that the identifying information is invalid (or alternatively in association with the initial creation of a token) and if the mobile device includes a fingerprint scanner, the mobile device application prompts the player to press the fingerprint scanner while engaging the gaming device, such as tapping the mobile device to a designated portion of the gaming device.

On the other hand, if the gaming system determines that the identifying information is valid, the system creates an authorization token. The system associates the authorization token with a timestamp of when the authorization token will expire. In certain embodiments, a cashless system includes a key distribution center which generates a session key to encrypt all cashless messages. The session key is rotated periodically at a configurable rate from 1 hour to 24 hours. In these embodiments, the system utilizes this session key to sign the token data and create a token. As such, the token time-to-live will be less than or equal to the session key rotation period. In other embodiments, such authorization tokens are managed utilizing software (and not a key distribution center).

Following the creation of an authorization token, the gaming system communicates the created authorization token to the mobile device, such as via one or more messages including the created authorization token, for storage by the mobile device application and proceeds with executing one or more of the requested actions and communicating a requested action response to the mobile device. For example, upon the creation of the authorization token, the component of a gaming establishment management system located inside the gaming device (i.e., a component of the gaming device), such as a NexGen™ player tracking component of an Advantage™. system, communicates the created authorization token to the mobile device and proceeds with executing the requested action.

On the other hand, following a determination that the mobile device application is associated with a previously created and stored authentication token, the mobile device application prompts the player to cause the mobile device to engage the gaming device, such as prompting the player to tap the mobile device to a designated portion of the gaming device.

Following the player causing the mobile device to engage the gaming device (e.g., the player taps the mobile device to a player tracking card reader or other designated location(s) of the gaming device), the mobile device application communicates, via a wireless communication protocol, the previously stored authorization token and the requested action to be performed to the gaming device (or to a component associated with the gaming device). For example, upon the player tapping the mobile device to a player tracking card reader or other designated location(s) of the gaming device, the mobile device application sends the stored authorization token and the requested action to a component of a gaming establishment management system located inside the gaming device (i.e., a component of the gaming device), such as a NexGen™ player tracking component of an Advantage™ system.

Following the communication of the stored authorization token and the requested action to the gaming device or a component associated with the gaming device, the system determines if the communicated authorization token is still valid. For example, a gaming system component configured to operate with a player tracking system determines whether the authorization token is valid (i.e., active and non-expired).

If the gaming system determines that the communication authorization token is invalid, the system communicates an invalid authorization token response to the mobile device. The mobile device application then displays one or more messages regarding the invalid authorization token and prompts the player to provide identifying information, such as a personal identification number or biometric identifier, to obtain another authentication token.

On the other hand, if the gaming system determines that the stored authorization token is valid, the system proceeds with executing the requested action. For example, upon the determination that the communicated authorization token is valid, the component of a gaming establishment management system located inside the gaming device proceeds with executing the requested action and communicates a requested action response to the mobile device.

Returning to FIG. 11A, the method can continue in step 1032 by the gaming server 116 determining transfer protocol and account verification rules based on the selected cryptocurrency. As noted above, each cryptocurrency can have a different account transfer protocol and/or account verification rules.

The method can continue in step 1036 by the gaming server 116 notifying the player of the activity to be performed in the account verification rules in order for the player to be determined to have authorization to perform actions using the wallet 154 identified by the public key provided by the player.

The method can continue in step 1140 by the gaming server 116 monitoring a communication interface for confirmation that the activity has been performed timely and correctly and, if so, sets an activity performance indicator to a first value and, if not, sets the activity performance indicator to a different second value. For a first set of account verification rules for a first cryptocurrency, the gaming server 116 determines that the activity was performed timely by comparing a notification that the action was performed against a timestamp associated with transmission of the request to the player to perform the action. For a second set of account verification rules for a second cryptocurrency, the gaming server 116 determines that the activity was performed correctly by comparing a cryptocurrency transfer initiated by the player on the digital ledger 158 against an amount of the transfer requested by the gaming server 116 and determining that the amounts match. For a third set of account verification rules for a third cryptocurrency, the gaming server 116 determines that the activity was performed correctly by using a public key to decrypt data signed with a private key of the player and either returned to the gaming server 116 or posted on the digital ledger. When the decrypted data matches data forwarded to the player by the gaming system, the gaming server determines that the activity was performed correctly. For a fourth set of account verification rules for a fourth cryptocurrency, the gaming server 116 determines that the activity was performed correctly by decrypting information signed with a private or secret key of the gaming establishment and either returned to the gaming server 116 or posted on the digital ledger. When the decrypted information matches results from processing encrypted data (without decryption by the player) forwarded to the player by the gaming system, the gaming server determines that the activity was performed correctly.

The method can continue in query 1144 by the gaming server 116 determining whether the activity performance was received timely and, if not, returns to and repeats step 1140. If activity performance was received timely, the gaming system proceeds to query 1148.

When the gaming system determines that the activity was not performed correctly in query 1148, the gaming system denies the transaction in step 1150.

When the gaming system determines that the activity was performed correctly in query 1148, the gaming system proceeds to step 1152 and proceeds to create the transaction data structure and debit the loyalty points in the loyalty point account of the player.

The method can continue in step 1156 by the gaming server 116 updating the transaction state in the transaction data structure and requesting credit of the cryptocurrency based on the conversion calculation points.

The method can continue in optional step 1156 by the gaming server 1160 causing transfer of the converted cryptocurrency to the selected player’s wallet 154.

The method can continue in step 1166 by the gaming server 116 notifying the selected player of the completed transaction details.

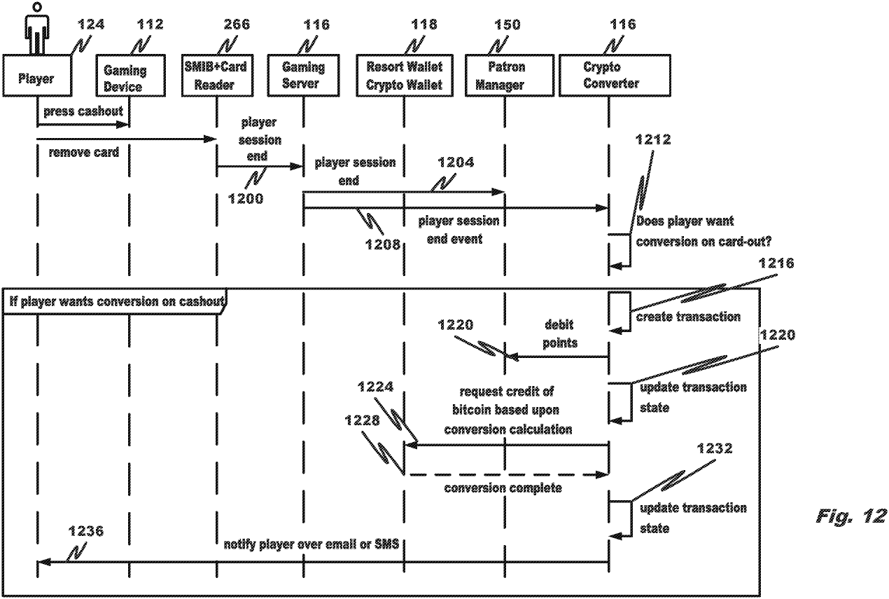

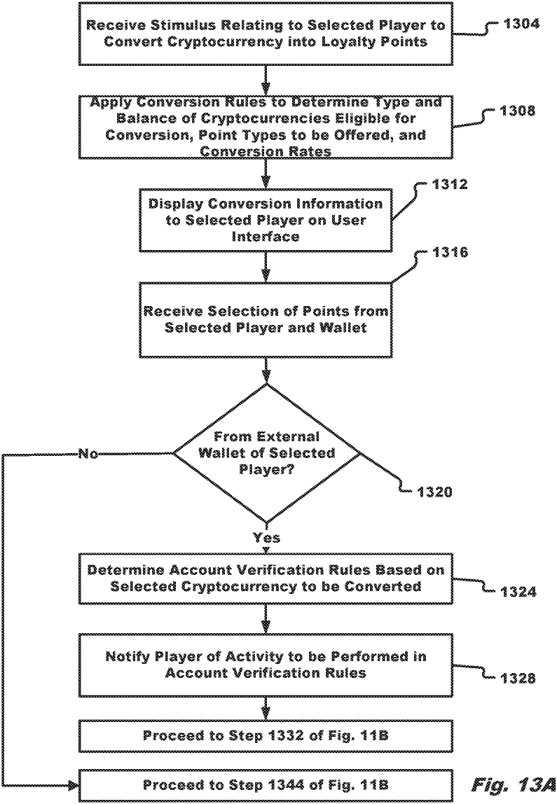

An embodiment of the method of FIGS. 11A and 11B is shown in FIG. 12. The embodiment shows that the player can configure the loyalty point to cryptocurrency conversion to happen automatically nightly, or at the end of his or her casino trip, once his or her accumulated loyalty balance hits some minimum threshold, or upon occurrence of any other appropriate conversion triggering event. For example, the player may elect to automatically convert his or her earned player loyalty points after the end of a play session at an EGM. Automated conversion might be tied to player loyalty status or play levels.

The player 124 presses the cashout button on the gaming device 112 and removes his or her card from the card reader 266. In response, the card reader 266 generates and sends a player session end message 1200 to a floor system component of the gaming system 100 that is in communication with the gaming server 116. The floor system component of gaming system component, in response, generates and sends a first message 1204 indicating that the player session has ended to the patron manager function 150 of the gaming server 116, which maintains in real time or at the end of the gaming session an accounting of loyalty points earned during the gaming session, and a second message 1208 indicating that occurrence of a player session end event to the cryptocurrency conversion function of the gaming server 116. While FIG. 12 shows that the floor system component publishes player gaming session end event, a player tracking system or the patron management function 150 can alternatively publish the event. The patron manager 150 increments the loyalty point balance of the player’s account to reflect any loyalty point award. The cryptocurrency conversion function of the gaming server 116 determines 1212 whether or not the player has elected an automatic cryptocurrency conversion on card out.

When the player wants conversion automatically on cashout, the cryptocurrency conversion function creates a data structure for a transaction and debits 1220 loyalty points to be converted into cryptocurrency. In various embodiments, the gaming system 100 maintains a transaction records log of transaction requests. Maintaining a transaction records log is useful for resolving disputes that may occur regarding transferring cryptocurrency funds to and/or from a gaming establishment fund management account. Maintaining a transaction records log may also be useful in assisting in investigations conducted by authorities. In certain embodiments, the transaction records log includes one or more of cryptocurrency account public keys, player identifiers, transaction amounts (e.g., number of loyalty points and cryptocurrency amount converted), conversion rate applied, timestamps, transaction status (e.g., pending, completed, etc.), etc.

The cryptocurrency conversion function of the gaming server 116 causes the patron manager function 150 to update 1220 the transaction state in the transaction data structure to reflect the debit of points by deducting the loyalty points to be converted from the player’s loyalty point balance.

The cryptocurrency conversion function of the gaming server 116 requests the resort wallet 118 to credit of Bitcoin based on the conversion calculation (or add the converted Bitcoin balance to the player’s account in the resort wallet 118) and the resort wallet 118 returns to the cryptocurrency conversion function a message 1228 when the conversion is completed. AS described above, different steps would be applied to transfer the cryptocurrency to an external wallet of the player. The intended destination wallet can be identified by a tag or flag in the data structure triggering an automatic transfer, which would have a first value for a transfer to the player’s account in the resort wallet and a second value for a transfer to the player’s external wallet.

The cryptocurrency conversion function, in response, updates 1232 the transaction state in the transaction data structure to reflect the completion of the conversion.

Finally, the cryptocurrency conversion function notifies the player over email or SMS or other message modality 1236 of the completion of the conversion of the loyalty points into cryptocurrency.

While FIG. 12 is discussed with reference to an automatic transfer, it is to be appreciated that the workflow can also apply to a player requested transfer at the time of cashout.

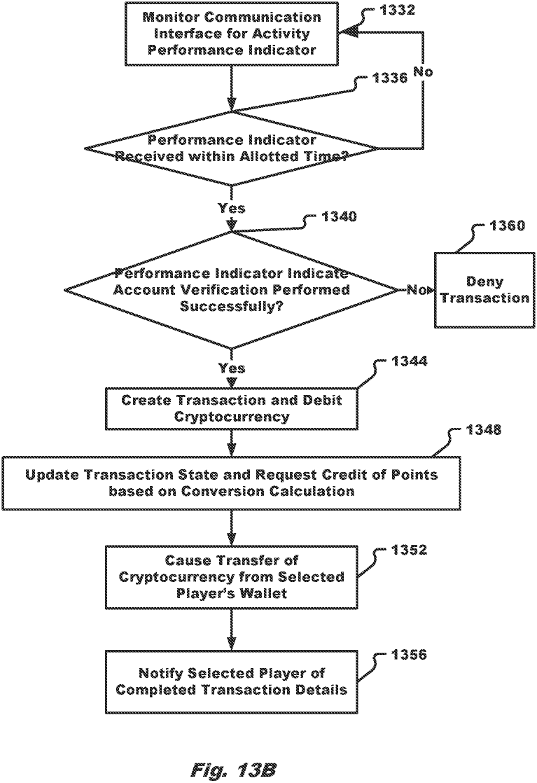

With reference now to FIGS. 13A and 13B, a method of exchanging cryptocurrency and loyalty points will be described in accordance with embodiments of the present disclosure.

The method begins in step 1304 by the gaming server 116 receiving a stimulus relating to offering a selected player an option to convert cryptocurrency into loyalty points. The stimulus can take many forms, including receipt of a player request, occurrence of a trigger event (such as detection of a minimum loyalty point balance in the player’s account or occurrence of a game event, system event, or random event, detection of a minimum amount of play by the player within a predetermined amount of time, detection of an amount of money spent at the gaming establishment within a predetermined amount of time, and the like).

The method can continue in step 1308 by the gaming server 116 applying conversion rules to determine a type and balance of cryptocurrency eligible for conversion, loyalty point types to be offered, conversion rates, and transfer options and in step 1312 displaying the conversion information to the selected player on a user interface.

The method can continue in step 1316 by the gaming server 116 receiving selection of the loyalty points and source cryptocurrency wallet from the selected player.

The method can continue in query 1320 by the gaming server 116 determining whether or not the player has selected an internal or external wallet as the source account for the cryptocurrency. When the player elects to transfer the cryptocurrency from an account in the resort wallet 118, the gaming server proceeds to step 1344 of FIG. 13B (discussed below). When the player elects to transfer the cryptocurrency from an external wallet 154 of the player, the gaming server 116 proceeds to step 1324.

The method can continue in step 1324 by the gaming server 116 determining transfer protocol and account verification rules based on the selected cryptocurrency. As noted above, each cryptocurrency can have a different account transfer protocol and/or account verification rules.

The method can continue in step 1328 by the gaming server 116 notifying the player of the activity to be performed in the account verification rules in order for the player to be determined to have authorization to perform actions using the wallet 154 identified by the public key provided by the player.

The method can continue in step 1332 by the gaming server 116 monitoring a communication interface for confirmation that the activity has been performed timely and correctly and, if so, setting an activity performance indicator to a first value and, if not, sets the activity performance indicator to a different second value. For a first set of account verification rules for a first cryptocurrency, the gaming server 116 determines that the activity was performed timely by comparing a notification that the action was performed against a timestamp associated with transmission of the request to the player to perform the action. For a second set of account verification rules for a second cryptocurrency, the gaming server 116 determines that the activity was performed correctly by comparing a cryptocurrency transfer initiated by the player on the digital ledger 158 against an amount of the transfer requested by the gaming server 116 and determining that the amounts match. For a third set of account verification rules for a third cryptocurrency, the gaming server 116 determines that the activity was performed correctly by using a public key to decrypt data signed with a private key of the player and either returned to the gaming server 116 or posted on the digital ledger. When the decrypted data matches data forwarded to the player by the gaming system, the gaming server determines that the activity was performed correctly. For a fourth set of account verification rules for a fourth cryptocurrency, the gaming server 116 determines that the activity was performed correctly by decrypting information signed with a private or secret key of the gaming establishment and either returned to the gaming server 116 or posted on the digital ledger. When the decrypted information matches results from processing encrypted data (without decryption by the player) forwarded to the player by the gaming system, the gaming server determines that the activity was performed correctly.

The method can continue in query 1336 by the gaming server 116 determining whether the activity performance was received timely and, if not, returns to and repeats step 1332. If activity performance was received timely, the gaming system proceeds to query 1340.

When the gaming system determines that the activity was not performed correctly in query 1340, the gaming system denies the transaction in step 1360.

When the gaming system determines that the activity was performed correctly in query 1340, the gaming system proceeds to step 1344 and proceeds to create the transaction data structure and debit the cryptocurrency in the resort wallet 118 or wallet 154 of the player.

The method can continue in step 1348 by the gaming server 116 updating the transaction state in the transaction data structure and requesting credit of the loyalty points based on the conversion calculation.

The method can continue in step 1352 by the gaming server 1160 causing transfer of the cryptocurrency from the selected wallet to the resort wallet of the gaming establishment.

The method can continue in step 1356 by the gaming server 116 notifying the selected player of the completed transaction details.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, microcode, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, RAM, ROM, EEPROM or Flash memory, an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

What is claimed is:

1. A method for digital ledger validation in a gaming system, comprising:
monitoring, by a microprocessor, player activity on a plurality of gaming devices;
in response to a monitored player activity of a selected player complying with a set of promotional rules, assigning, by the microprocessor, a loyalty point to the selected player, the loyalty point being assigned independently of an outcome of a game on the plurality of gaming devices;
receiving, by the microprocessor, a request to convert the loyalty point into a selected cryptocurrency for transfer into a digital account associated with the selected player;
determining, by the microprocessor, that the selected player request complies with a set of conversion rules different from the set of promotional rules;
in response to the determining, applying, by the microprocessor, a first conversion ratio associated with the selected cryptocurrency to the loyalty point to provide a converted amount of the selected cryptocurrency; and
causing the digital account of the selected player to be updated to reflect the applying by decrementing a loyalty point balance of the selected player and incrementing a balance of the selected cryptocurrency.

2. The method of claim 1, wherein the loyalty point is a nonmonetary reward that is redeemable for a discount on one or more of a game play feature, a good, and a service and further comprising:
providing the selected player with a set of loyalty conversion options, each loyalty conversion option comprising conversion of the loyalty point into a respective type of cryptocurrency different from a type of cryptocurrency associated with a different loyalty conversion option and one of the loyalty conversion options comprises a loyalty conversion option to convert the loyalty point into the selected cryptocurrency, wherein each of the loyalty conversion options in the set of loyalty conversion options has a respective conversion ratio different from a conversion ratio associated with a different loyalty conversion option and each respective conversion ratio corresponds to an expiration time after which the respective conversion ratio is no longer valid.

3. The method of claim 2, wherein the digital account corresponds to a public and private key pair associated with the selected player, wherein an electronic address of the digital account is derived from the public key, wherein the set of conversion rules requires a minimum loyalty point balance for conversion to occur, and wherein, when the digital account comprises the minimum loyalty point balance, the applying occurs automatically upon occurrence of a predetermined event.

4. The method of claim 2, wherein the digital account corresponds to a public and private key pair not associated with the selected player, wherein a balance of the selected cryptocurrency in the digital account is shared by multiple players including the selected player, wherein the digital account comprises, for each player of the multiple players, an indicator of an allocable share of the cryptocurrency balance owned by the corresponding player, and wherein the set of conversion rules requires different categories of players to have different sets of loyalty conversion options.

5. The method of claim 2, wherein the digital account comprises a first digital account corresponding to a first public and private key pair associated with the selected player and a second digital account corresponding to a second public and private key pair not associated with the selected player, wherein the set of conversion rules conditions the applying on one or more of an amount of game play by the selected player over a selected time interval, an amount of money spent by the selected player over the selected time interval, occurrence of a game event, occurrence of a system event, and occurrence of a random event, and wherein the set of conversion rules permits the selected player to transfer the converted amount of the selected cryptocurrency to the second digital account but not the first digital account.

6. The method claim 1, further comprising:
receiving, by the microprocessor, a further request from the selected player to convert the converted amount of the selected cryptocurrency into a loyalty point;
determining, by the microprocessor, that the selected player request complies with the set of conversion rules;
in response to the determining, further applying, by the microprocessor, a second conversion ratio different from the first conversion ratio, and the second conversion ratio being associated with the selected cryptocurrency, to the converted amount of the selected cryptocurrency to provide a converted amount of the loyalty point; and
causing the digital account of the selected player to be updated to reflect the further applying by decrementing a balance of the selected cryptocurrency and incrementing a loyalty point balance.

7. The method of claim 1, further comprising:
determining, for the selected cryptocurrency, a corresponding set of account verification rules, wherein each cryptocurrency corresponds to a different set of account verification rules;
requiring, as part of digital account verification, the selected player to perform an activity set forth in the corresponding set of account verification rules;
monitoring a communications interface for an activity performance;
when the activity performance indicates that the selected player performed the activity successfully, determining that the selected player owns the digital account and thereafter performing the determining, applying and causing; and
when the activity performance indicates that the selected player failed to perform the activity successfully, determining that the selected player does not own the digital account and thereafter not performing the determining, applying and causing.

8. A gaming server comprising:
a communications interface to receive and send communications over a network;
a microprocessor coupled with the communications interface; and
a memory coupled with and readable by the microprocessor and storing therein a set of instructions which, when executed by the microprocessor causes the microprocessor to:
monitor player activity on a plurality of gaming devices;
in response to a monitored player activity of a selected player complying with a set of promotional rules, assign a loyalty point award to the selected player, the loyalty point award being assigned independently of an outcome of a game on the plurality of gaming devices;
receive a request to convert the loyalty point award into a selected cryptocurrency for transfer into a digital account associated with the selected player;
determine that the selected player request complies with a set of conversion rules different from the set of promotional rules;
in response to the determining, apply a first conversion ratio associated with the selected cryptocurrency to the loyalty point award to provide a converted amount of the selected cryptocurrency; and
cause the digital account of the selected player to be updated to reflect the applying by decrementing a loyalty point balance of the selected player and incrementing a balance of the selected cryptocurrency.

9. The gaming server of claim 8, wherein the loyalty point award is a nonmonetary reward that is redeemable for a discount on one or more of a game play feature, a good, and a service and wherein the set of instructions, when executed by the microprocessor causes the microprocessor to:
provide the selected player with a set of loyalty conversion options, each loyalty conversion option comprising conversion of the loyalty into a respective type of cryptocurrency different from a type of cryptocurrency associated with a different loyalty conversion option and one of the loyalty conversion options comprises a loyalty conversion option to convert the loyalty point award into the selected cryptocurrency, wherein each of the loyalty conversion options in the set of loyalty conversion options has a respective conversion ratio different from a conversion ratio associated with a different loyalty conversion option and each respective conversion ratio corresponds to an expiration time after which the respective conversion ratio is no longer valid.

10. The gaming server of claim 9, wherein the digital account corresponds to a public and private key pair associated with the selected player, wherein an electronic address of the digital account is derived from the public key, wherein the set of conversion rules requires a minimum loyalty point balance for conversion to occur, and wherein, when the digital account comprises the minimum loyalty point balance, the applying occurs automatically upon occurrence of a predetermined event.

11. The gaming server of claim 9, wherein the digital account corresponds to a public and private key pair not associated with the selected player, wherein a balance of the selected cryptocurrency in the digital account is shared by multiple players including the selected player, wherein the digital account comprises, for each player of the multiple players, an indicator of an allocable share of the balance owned by the corresponding player, and wherein the set of conversion rules requires different categories of players to have different sets of loyalty conversion options.

12. The gaming server of claim 9, wherein the digital account comprises a first digital account corresponding to a first public and private key pair associated with the selected player and a second digital account corresponding to a second public and private key pair not associated with the selected player, wherein the set of conversion rules conditions the applying on one or more of an amount of game play by the selected player over a selected time interval, an amount of money spent by the selected player over the selected time interval, occurrence of a game event, occurrence of a system event, and occurrence of a random event, and wherein the set of conversion rules permit the selected player to transfer the converted amount of the selected cryptocurrency to the second digital account but not the first digital account.

13. The gaming server of claim 8, wherein the set of instructions, when executed by the microprocessor causes the microprocessor to:
receive a further request from the selected player to convert the converted amount of the selected cryptocurrency into loyalty points;
determine that the selected player request complies with the set of conversion rules;
in response to the determination, further apply a second conversion ratio different from the first conversion ratio, the second conversion ratio being associated with the selected cryptocurrency to the converted amount of the selected cryptocurrency to provide a converted amount of the loyalty points; and
cause the digital account of the selected player to be updated to reflect the further applying by decrementing a balance of the selected cryptocurrency and incrementing a loyalty point balance.

14. The gaming server of claim 8, wherein the set of instructions, when executed by the microprocessor causes the microprocessor to:
determine, for the selected cryptocurrency, a corresponding set of account verification rules, wherein each cryptocurrency corresponds to a different set of account verification rules;
require, as part of digital account verification, the selected player to perform an activity set forth in the corresponding set of account verification rules;
monitor an activity performance;
when the activity performance indicates that the selected player performed the activity successfully, determine that the selected player owns the digital account and thereafter perform the determining, applying and causing; and
when the activity performance indicates that the selected player did not perform the activity successfully, determine that the selected player does not own the digital account and thereafter not performing the determining, applying and causing.

15. A gaming system comprising:
a display to render gaming information in a gaming session to a player;
a user interface to receive player input;
a communications interface that facilitates communications with the player;
a microprocessor coupled with the display, user interface, and communications interface; and
a computer memory coupled with the microprocessor, the computer memory comprising a microprocessor-executable set of instructions that, when executed by the microprocessor, causes the microprocessor to:
receive a request to convert loyalty points from game play by a selected player into a selected cryptocurrency for transfer into a digital account associated with the selected player, wherein the loyalty points are awarded independently of an outcome of the game play;
determine, for the selected cryptocurrency, a corresponding set of account verification rules, wherein each cryptocurrency corresponds to a different set of account verification rules;
require, as part of digital account verification, the selected player, using a private key of the digital account, to perform an activity set forth in the corresponding set of account verification rules;
monitor for an activity performance;
when the activity performance indicates that the selected player performed the activity successfully, determine that the selected player is authorized to perform transactions using the digital account;
in response to the selected player being authorized to perform transactions using the digital account, determine that the selected player request complies with a set of conversion rules different from the sets of promotional rules and account verification rules;
in response to the determination that the request complies with the set of conversion rules, apply to the loyalty points a first conversion ratio associated with the selected cryptocurrency to provide a converted amount of the selected cryptocurrency;
cause the digital account of the selected player to be updated to reflect the applying by decrementing a loyalty point balance of the selected player and incrementing a balance of the selected cryptocurrency; and
when the activity performance indicates that the selected player failed to perform the activity successfully, determine that the selected player is not authorized to perform transactions using the digital account and thereafter deny the request of the selected player.

16. The gaming system of claim 15, wherein the digital account corresponds to a public and private key pair associated with the selected player, wherein an electronic address of the digital account is derived from the public key, wherein the loyalty points are a nonmonetary reward that is redeemable for a discount on one or more of a game play feature, a good, and a service, and wherein the set of instructions that, when executed by the microprocessor, causes the microprocessor to:
provide the selected player with a set of loyalty conversion options, each loyalty conversion option comprising conversion of the loyalty into a respective type of cryptocurrency different from a type of cryptocurrency associated with a different loyalty conversion option and one of the loyalty conversion options comprises a loyalty conversion option to convert the loyalty into the selected cryptocurrency, wherein each of the loyalty conversion options in the set of loyalty conversion options has a respective conversion ratio different from a conversion ratio associated with a different loyalty conversion option and each respective conversion ratio corresponds to an expiration time after which the respective conversion ratio is no longer valid.

17. The gaming system of claim 15, wherein the set of instructions, when executed by the microprocessor causes the microprocessor to:
receive a further request from the selected player to convert the converted amount of the selected cryptocurrency into loyalty points;
determine that the selected player request complies with the set of conversion rules;
in response to the determination, further apply a second conversion ratio different from the first conversion ratio, the second conversion ratio being associated with the selected cryptocurrency to the converted amount of the selected cryptocurrency to provide a converted amount of the loyalty points; and
cause the digital account of the selected player to be updated to reflect the further applying by decrementing a balance of the selected cryptocurrency and incrementing a loyalty point balance.

18. The gaming system of claim 15, wherein the digital account is a simple deterministic cryptocurrency wallet, wherein the activity comprises the selected player using the private key to encrypt a string of characters randomly generated by the microprocessor, and wherein the selected player performs the activity successfully when a public key associated with the digital account decrypts the encrypted string of characters.

19. The gaming system of claim 15, wherein the activity comprises a second digital account receiving from the digital account of the selected player a cryptocurrency transfer within a specified time interval and wherein the monitoring for activity performance comprises monitoring a digital ledger for validation of a transaction initiated by the selected player.

20. The gaming system of claim 15, wherein the digital account is a multi-signature non-deterministic wallet, wherein the activity comprises the selected player and at least one other person to use different private keys to encrypt a string of characters generated by the microprocessor, wherein the selected player performs the activity successfully when a public key associated with the digital account decrypts the encrypted string of characters, and wherein the monitoring for activity performance comprises monitoring the communications interface for the encrypted string of characters.
